(19) United States
(12) Patent Application Publication
(10) Pub. No.: US 2016/0179599 A1
(43) Pub. Date: Jun. 23, 2016

(54) DATA PROCESSING FRAMEWORK FOR DATA CLEANSING

(71) Applicants: Chevron U.S.A. Inc., San Ramon, CA (US); University of Southern California, Los Angeles, CA (US)

(72) Inventors: Alisha Deshpande, Los Angeles, CA (US); Yining Dong, Los Angeles, CA (US); Gang Li, Los Angeles, CA (US); Yingying Zheng, Thousand Oaks, CA (US); Si-Zhao Qin, Arcadia, CA (US); Lisa Ann Brenskelle, Houston, TX (US)

(73) Assignees: University of Southern California, Los Angeles, CA (US); Chevron U.S.A. Inc., San Ramon, CA (US)

(21) Appl. No.: 14/937,701

(22) Filed: Nov. 10, 2015

Related U.S. Application Data
(63) Continuation-in-part of application No. 13/781,623, filed on Feb. 28, 2013.
(60) Provisional application No. 62/077,861, filed on Nov. 10, 2014.
(60) Provisional application No. 61/712,592, filed on Oct. 11, 2012.

(51) Int. Cl. G06F 11/07; H04L 29/06

(52) U.S. Cl. CPC G06F 11/079; G06F 11/0709; G06F 11/0751; H04L 65/4069; H04L 65/601

(57) ABSTRACT

A computer-implemented method for reconstructing data includes receiving a selection of one or more input data streams at a data processing framework. The method can include determining existence of a fault in the input data stream(s). This determination can be based on receiving a definition of one or more analytics components at the data processing framework and applying a dynamic principal component analysis (DPCA) to the input data streams. Detection of the fault can be based at least in part on a prediction error and a variation in principal component subspace generated based on the DPCA. Detection of the fault can also be based on performing a wavelet transform to generate a set of coefficients defining the data stream, the set of coefficients including one or more coefficients representing a high frequency portion of data included in the data stream. The method can include reconstructing data at the fault.

### CROSS-REFERENCE TO RELATED APPLICATIONS

The present application claims priority from U.S. Provisional Patent Application No. 62/077,861, filed on Nov. 10, 2014, the disclosure of which is incorporated by reference in its entirety. The present application further claims priority as a continuation-in-part application from U.S. application Ser. No. 13/781,623, filed on Feb. 28, 2013, which claims priority from U.S. Provisional Patent Application No. 61/712,592, filed on Oct. 11, 2012, the disclosures of both of which are also hereby incorporated by reference in their entireties.

### TECHNICAL FIELD

The present application relates generally to the field of data cleansing. In particular, the present disclosure relates to a data processing framework for data cleansing.

### BACKGROUND

Oil production facilities are large scale operations, often including hundreds or even thousands of sensors used to measure pressures, temperatures, flow rates, levels, compositions, and various other characteristics. The sensors included in such facilities may provide a wrong signal, and sensors may fail. Accordingly, process measurements are inevitably corrupted by errors during the measurement, processing and transmission of the measured signal. These errors can take a variety of forms. These can include duplicate values, null/unknown values, values that exceed data range limits, outlier values, propagation of suspect or poor quality data, and time ranges of missing data due to field telemetry failures. Other errors may exist as well.

The quality of the oil field data significantly affects the oil production performance and the profit gained from using various data and/or analysis systems for process monitoring, online optimization, and control. Unfortunately, based on the various errors that can occur, oil field data often contain errors and missing values that invalidate the information used for production optimization.

To improve the accuracy of process data, fault detection techniques have been developed to determine when and how such sensors fail. For example, data driven models including principal component analysis (PCA) or partial least squares (PLS) have been developed to monitor process statistics to detect such failures. Furthermore, a Kalman filter can be used to develop interpolation methods for detecting outliers and reconstructing missing data streams.

However, the above existing solutions have drawbacks. For the estimation of a data point at a particular time, Kalman prediction only uses the past data, while Kalman smoothing only uses the future data. Accordingly, if only partial data is available at a particular time, the Kalman prediction arrangement is unavailable. Conversely, a Kalman filter cannot make use of partial information for purposes of data reconstruction. Accordingly, data reconstruction may not be available in cases where data changes over time, and where all data is not available for analysis (e.g., in dynamic systems where data changes rapidly).

Still further challenges exist with respect to data cleansing. For example, existing systems do not provide a system that is configurable for each possible problem in data to be cleansed, or particular types of data, and do not provide a system that is readily scalable to large-scale data collection systems. Additionally, existing systems are implemented within a shell monitoring application program, which limits the scalability of such systems. Additionally, existing commercial efforts do not address temporal and spatial considerations when considering possible sensor failure detection issues.

Still further drawbacks exist with respect to current data cleansing systems. For example, there may be field instruments in a facility that are somewhat isolated and do not have any significant correlation with any other field instrument. For such field instruments, an approach which depends on correlation between input variables to a model to detect data errors cannot be applied.

Still further, once a fault is detected, more analysis is often required to determine which input variable is faulty. One approach to doing so uses reconstruction-based contribution which determines which input to the PCA model contributes most to exceeding the statistical threshold. The input with the largest contribution is deemed to be faulty. Once the faulty input is identified, the PCA model can then be used to calculate a corrected value for that input, given values of the other inputs and the model itself. When the fault is reconstructed, the statistical indices fall back within their thresholds. However, because PCA is a steady-state modeling technique, it tends to generate alarms when dynamic behavior occurs, e.g., in industrial processes. These alarms upon dynamic behavior can lead to false detection, identification and reconstruction of data that is actually not erroneous.

For the above and other reasons, improvements in detection and addressing errors in dynamic systems are desirable.

### SUMMARY

In accordance with the present disclosure, the above and other issues are addressed by the following:

In a first aspect, a method for detecting faulty data in a data stream is disclosed. The method includes receiving an input data stream at a data processing framework and performing a wavelet transform on the data stream to generate a set of coefficients defining the data stream, the set of coefficients including one or more coefficients representing a high frequency portion of data included in the data stream. The method further includes determining, based on the high frequency portion of data, existence of a fault in the input data stream.

In a second aspect, a system includes a communication interface configured to receive a data stream, a processing unit, and a memory communicatively connected to the processing unit. The memory stores instructions which, when executed by the processing unit, cause the system to perform a method of detecting faulty data in the data stream. The method includes performing a wavelet transform on the data stream to generate a set of coefficients defining the data stream, the set of coefficients including one or more coefficients representing a high frequency portion of data included in the data stream, and determining, based on the high frequency portion of data, existence of a fault in the input data stream.

In a third aspect, a computer-readable medium having computer-executable instructions stored thereon which, when executed by a computing system, cause the computing system to perform a method for reconstructing data for a dynamic data set having a plurality of data points. The method includes receiving an input data stream at a data processing framework and performing a wavelet transform on the data stream to generate a set of coefficients defining the data stream, the set of coefficients including one or more coefficients representing a high frequency portion of data included in the data stream. The method also includes determining, based on the high frequency portion of data, existence of a fault in the input data stream, and reconstructing data at the fault using a recursive least squares process. The recursive least squares process has a forgetting factor defining relative weighting of previous data received in the input data stream.

In a fourth aspect, a computer-implemented method for reconstructing data is disclosed. The method includes receiving a selection of one or more input data streams at a data processing framework, and receiving a definition of one or more analytics components at the data processing framework. The method includes applying a dynamic principal component analysis to the one or more input data streams and detecting a fault in the one or more input data streams based on at least one of a prediction error or a variation in principal component subspace generated based on the dynamic principal component analysis. The method further includes identifying at least one of the one or more input data streams as a contributor to the fault based at least in part on a determination of a reconstruction-based contribution of the at least one input data stream to the fault, and reconstructing data at the fault within the one or more input data streams.

### BRIEF DESCRIPTION OF THE DRAWINGS

FIG. 1 illustrates a system in which the scalable data processing framework for dynamic data cleansing can be implemented in the context of an oil production facility, in an example embodiment;

FIG. 2 illustrates an example method for reconstructing data for a data set having a plurality of data points, according to an example embodiment;

FIG. 3 illustrates an example method for reconstructing dynamic data, according to an example embodiment;

FIG. 4 illustrates a pipelined framework for scalably performing data processing operations including dynamic data cleansing, according to an example embodiment;

FIG. 5 illustrates a high-level workflow of the implementation-level design for the scalable data processing framework disclosed herein;

FIG. 6 illustrates an example user interface for implementing the scalable data processing framework disclosed herein;

FIG. 7 illustrates an example analysis definition user interface for the scalable data processing framework disclosed herein;

FIG. 8 illustrates the example analysis definition user interface of FIG. 7 for the scalable data processing framework disclosed herein, including a defined analysis process for a particular dynamic data set;

FIG. 9 illustrates an example data flow within the scalable data processing framework disclosed herein;

FIG. 10 illustrates example process adapter arrangements useable within the scalable data processing framework disclosed herein;

FIG. 11 illustrates example process adapter and operator definitions useable within the scalable data processing framework disclosed herein;

FIG. 12 illustrates an average process time as a function of a number of tags used, showing scalability of the data processing framework discussed herein;

FIG. 13 illustrates an average process time as a function of a number of plans used, showing scalability of the data processing framework discussed herein;

FIG. 14 illustrates an example chart representing dynamic principal component analysis for a step fault, in an example embodiment of the data cleansing processes discussed herein;

FIG. 15 illustrates an example chart representing principal component analysis for a step fault, in an example embodiment of the data cleansing processes discussed herein;

FIG. 16 illustrates example experimental results for forward data reconstruction in the event that a first of three sensors are missing, in an example illustration of the data cleansing processes discussed herein;

FIG. 17 is a graph of T² indices in example experimental results when a first of three sensors are missing, in an example illustration of the data cleansing processes discussed herein;

FIG. 18 illustrates example experimental results for forward data reconstruction in the event that a second of three sensors are missing, in an example illustration of the data cleansing processes discussed herein;

FIG. 19 is a graph of T² indices in example experimental results when a second of three sensors are missing, in an example illustration of the data cleansing processes discussed herein;

FIG. 20 illustrates example experimental results for forward data reconstruction in the event that a third of three sensors are missing, in an example illustration of the data cleansing processes discussed herein;

FIG. 21 is a graph of T² indices in example experimental results when a third of three sensors are missing, in an example illustration of the data cleansing processes discussed herein;

FIG. 22 illustrates example experimental results for forward data reconstruction in the event that a first and second of three sensors are missing, in an example illustration of the data cleansing processes discussed herein;

FIG. 23 is a graph of T² indices in example experimental results when first and second of three sensors are missing, in an example illustration of the data cleansing processes discussed herein;

FIG. 24 illustrates example experimental results for forward data reconstruction in the event that a first and third of three sensors are missing, in an example illustration of the data cleansing processes discussed herein;

FIG. 25 is a graph of T² indices in example experimental results when first and third of three sensors are missing, in an example illustration of the data cleansing processes discussed herein;

FIG. 26 illustrates example experimental results for forward data reconstruction in the event that a second and third of three sensors are missing, in an example illustration of the data cleansing processes discussed herein;

FIG. 27 is a graph of T² indices in example experimental results when second and third of three sensors are missing, in an example illustration of the data cleansing processes discussed herein;

FIG. 28 illustrates example experimental results for forward data reconstruction in the event that three sensors are missing, in an example illustration of the data cleansing processes discussed herein;

FIG. 29 is a graph of T² indices in example experimental results when three of three sensors are missing, in an example illustration of the data cleansing processes discussed herein;

FIG. 30 illustrates example experimental results for backwards data reconstruction in the event that a first of three sensors are missing, in an example illustration of the data cleansing processes discussed herein;

FIG. 31 illustrates example experimental results for backwards data reconstruction in the event that a second of three sensors are missing, in an example illustration of the data cleansing processes discussed herein;

FIG. 32 illustrates example experimental results for backwards data reconstruction in the event that a third of three sensors are missing, in an example illustration of the data cleansing processes discussed herein;

FIG. 33 illustrates example experimental results for backwards data reconstruction in the event that a first and second of three sensors are missing, in an example illustration of the data cleansing processes discussed herein;

FIG. 34 illustrates example experimental results for backwards data reconstruction in the event that a first and third of three sensors are missing, in an example illustration of the data cleansing processes discussed herein;

FIG. 35 illustrates example experimental results for backwards data reconstruction in the event that a second and third of three sensors are missing, in an example illustration of the data cleansing processes discussed herein;

FIG. 36 illustrates example experimental results for backwards data reconstruction in the event that three sensors are missing, in an example illustration of the data cleansing processes discussed herein.

FIG. 37 illustrates a chart depicting the results of DPCA-based data cleansing on a null value error;

FIG. 38 illustrates a chart depicting the results of DPCA-based data cleansing on a spike value error;

FIG. 39 illustrates a chart depicting the results of DPCA-based data cleansing on a drift value error;

FIG. 40 illustrates a chart depicting the results of DPCA-based data cleansing on a bias error;

FIG. 41 illustrates a chart depicting the results of DPCA-based data cleansing on a frozen value error;

FIG. 42 illustrates a further example method for reconstructing data from a single data stream having a plurality of data points, according to an example embodiment;

FIG. 43A illustrates a method of batch fault detection using a wavelet transform, according to an example embodiment;

FIG. 43B illustrates a method of realtime fault detection using a wavelet transform, according to an example embodiment;

FIG. 44 illustrates a method of performing a fault reconstruction using auto-regressive recursive least squares, according to an example embodiment;

FIG. 45 is a block diagram of an auto-regressive recursive least squares implementation, according to an example embodiment;

FIG. 46 illustrates a method of performing a faulty data reconstruction from a data stream in which faults have been detected, according to an example embodiment;

FIG. 47 illustrates a chart depicting a frozen value detected in a single data stream fault detection and reconstruction system;

FIG. 48 illustrates a chart depicting a linear drift error detected in a single data stream fault detection and reconstruction system;

FIG. 49 illustrates a chart depicting error detection of a spiked value detected in a single data stream fault detection and reconstruction system;

FIG. 50 illustrates a chart depicting detection and reconstruction of a null value detected in a single data stream fault detection and reconstruction system; and

FIG. 51 illustrates a chart depicting an example wavelet-based fault detection, according to an example embodiment.

### DETAILED DESCRIPTION

As briefly described above, embodiments of the present invention are directed to data cleansing systems and methods, for example to provide dynamic data reconstruction based on dynamic data. The systems and methods of the present disclosure provide for data reconstruction that has improved flexibility as compared to the traditional Kalman filter in that they can optionally use partial data available at a particular time. Therefore, the methods discussed herein provide for reconstruction of missing or faulty sensor values irrespective of the number of sensors that are missing or faulty. In some embodiments discussed here, both forward data reconstruction (FDR) and backward data reconstruction (BDR) are used to provide for data reconstruction. Additionally, contributions of specific inputs to a fault or error can be determined, thereby isolating the likely cause, or greatest contributor, to a fault occurring, thereby allowing a faulty sensor to be identified.

Concepts of the present disclosure are further described in “Missing Value Replacement in Multivariate Data Modeling, Part II: Dynamic PCA Models” by Yining Dong, Yingying Zheng, S. Joe Qin, and Lisa Brenskelle; and “Advanced Streaming Data Cleansing” by Alisha Deshpande, Yining Dong, Gang Li, Yingying Zheng, Si-Zhao Qin, and Lisa A. Brenskelle, the contents of both of which are incorporated herein by reference in their entireties.

In still further aspects, the present disclosure relates to cleansing of individual data streams, for example by using wavelet transforms to isolate a high frequency portion of the data stream. Based on observations relating to that high frequency portion (e.g., whether it is unchanging, monotonically increasing/decreasing, or otherwise represents a signal unlikely to be accurate), a fault can be detected in a single input data stream. A recursive least squares method can be used to reconstruct data determined to be faulty, in some cases by also applying a forgetting factor to past data. Such single data stream fault detection and reconstruction mechanisms can be used on either batches of data from a data stream or in realtime, according to some implementations.

In accordance with the following disclosure, the systems and methods herein provide a number of advantages over existing systems. In some embodiments, the systems and methods described herein provide for real-time monitoring and decision making regarding dynamic data, allowing for “on the fly” data cleansing while data is being collected. Additionally, based on the pipelined, modular architecture described in further detail below, the methods and systems described herein are highly scalable to a large number (e.g., hundreds of thousands) of data streams. The systems and methods described herein also are configurable by non-expert users, and can be reused in various contexts and applications. Additionally, as data cleansing operators are developed, they can be integrated into the framework described herein, ensuring that the systems are extensible and comprehensive of various data cleansing issues.

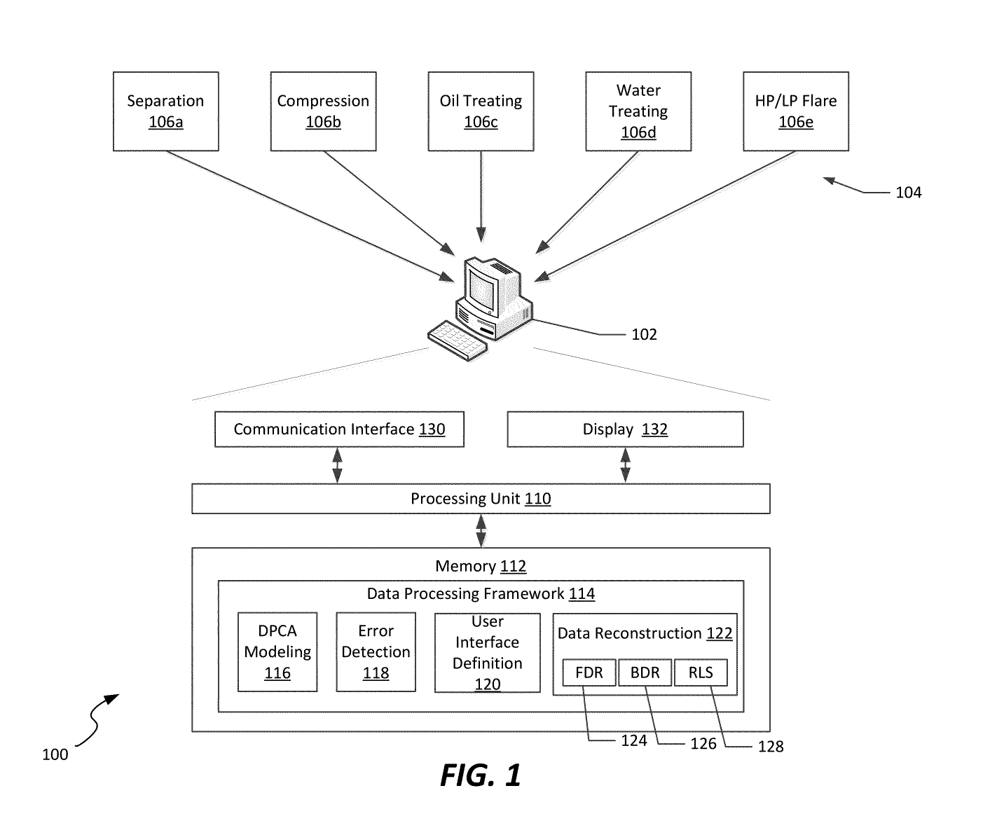

Referring now to FIG. 1, an example system 100 used to implement a scalable data processing framework, as provided by the present disclosure. In particular, the example system 100 integrates a plurality of data streams of different types from an oil production facility, such as an oil field. As illustrated in the embodiment shown, a computing system 102 receives data from an oil production facility 104, which includes a plurality of subsystems, including, for example, a separation system 106a, a compression system 106b, an oil treating system 106c, a water treating system 106d, and an HP/LP Flare system 106e.

The oil production facility 104 can be any of a variety of types of oil production facilities, such as a land-based or offshore drilling system. In the embodiment shown, the subsystems of the oil production facility 104 each are associated with a variety of different types of data, and have sensors that can measure and report that data in the form of data streams. For example, the separation system 106a may include pressure and temperature sensors and associated sensors that test backpressure as well as inlet and outlet temperatures. In such a system, various errors may occur, for example valve stiction or other types of error conditions. The compression system 106b can include a pressure control for monitoring suction, as well as a variety of stage discharge temperature controllers and associated sensors. In addition, the oil treating system 106c, water treating system 106d, and HP/LP Flare system 106e can each have a variety of types of sensors, including pressure and temperature sensors, that can be periodically sampled to generate a data stream to be monitored by the computing system 102. It is recognized that the various system 106a-e are intended as exemplary, and that various other systems could have sensors that are be incorporated into data streams provided to the computing system 102 as well.

In the embodiment shown, the computing system 102 includes a processor 110 and a memory 112. The processor 110 can be any of a variety of types of programmable circuits capable of executing computer-readable instructions to perform various tasks, such as mathematical and communication tasks.

The memory 112 can include any of a variety of memory devices, such as using various types of computer-readable or computer storage media. A computer storage medium or computer-readable medium may be any medium that can contain or store the program for use by or in connection with the instruction execution system, apparatus, or device. In example embodiments, the computer storage medium is embodied as a computer storage device, such as a memory or mass storage device. In particular embodiments, the computer-readable media and computer storage media of the present disclosure comprise at least some tangible devices, and in specific embodiments such computer-readable media and computer storage media include exclusively non-transitory media.

In the embodiment shown, the memory 112 stores a data processing framework 114. The data processing framework 114 performs analysis of dynamic data, such as is received in data streams (e.g., from an oil production facility 104), for detecting and reconstructing faults in data.

In the embodiment shown, the data processing framework 114 includes a DPCA modeling component 116, an error detection component 118, a user interface definition component 120, and a data reconstruction component 122.

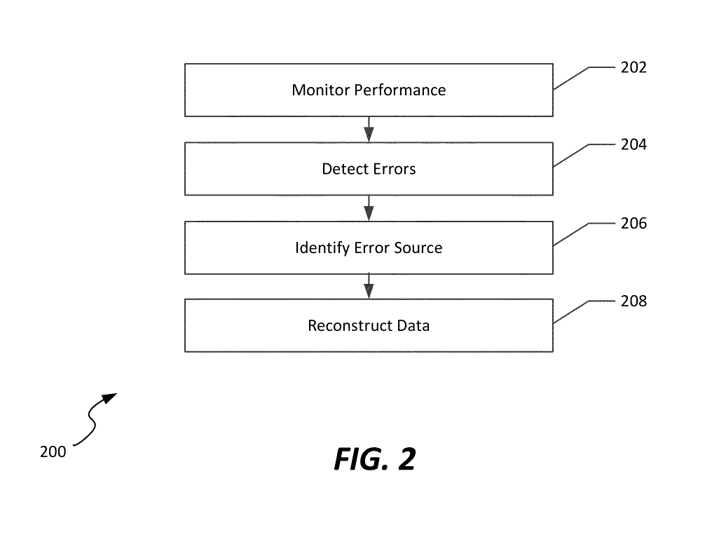

The DPCA modeling component 116 receives dynamic data, for example from a data stream, and performs a principal component analysis on that data, as discussed in further detail below. For example, the DPCA modeling component 116 can perform a principal component analysis using measured variables that are not characterized as input and output variables, but rather are related to a number of latent variables to represent their respective correlations. An example of such analysis is discussed below in connection with FIG. 2.

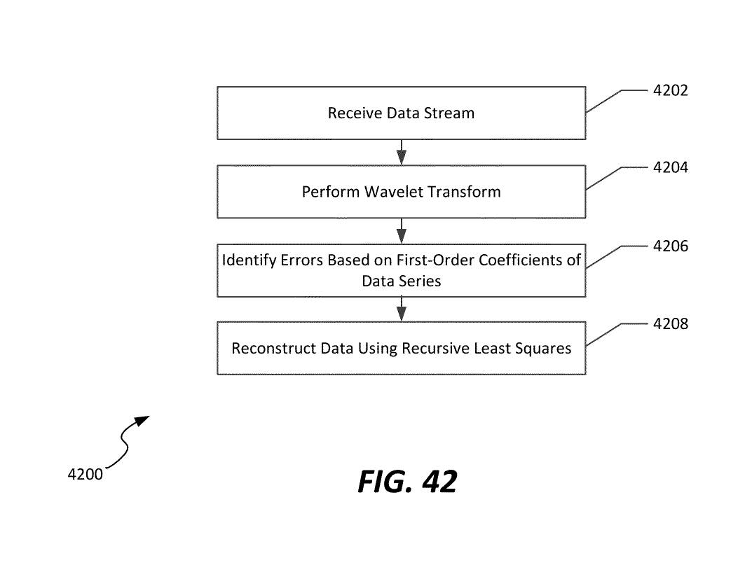

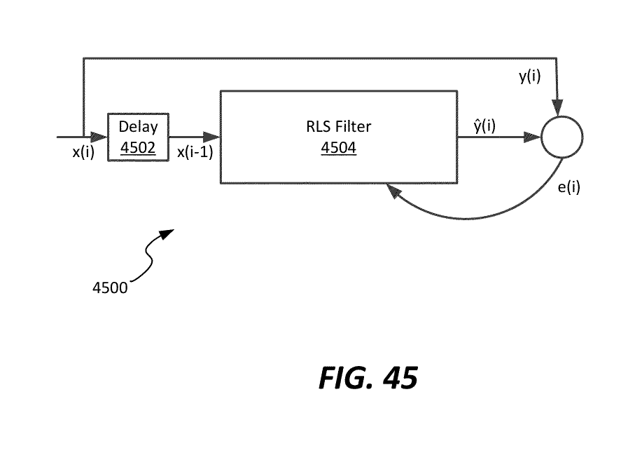

The error detection component 118 detects errors in the received one or more data streams. In some cases, the error detection component can be based at least in part on the analysis performed by the DPCA modeling component 116. In some embodiments, the error detection component 118 receives a threshold from a user, for example as entered into user interface component 120 that defines a threshold at which a fault would likely be occurring. In other embodiments, the error detection component 118 implements a single tag fault detection operation, such as is discussed below in connection with FIGS. 42-51. In further embodiments, one or both of the error detection component 118 and the data reconstruction component 122 provides faulty sensor identification as well, discussed in further detail below in connection with FIG. 2.

The user interface definition component 120 presents to a user a configurable arrangement with which the scalable data framework can be configured to receive input streams and arrange analyses of those input streams, thereby allowing a user to define various analyses to be performed on the input data streams. This can include, for example, a configurable analysis of multiple data streams based on DPCA modeling and fault detection, as well as data reconstruction, as further discussed below. The steps for DPCA-based data cleansing method are: error detection, faulty sensor/input identification, and reconstruction of the faulty sensor data. It can also include, for example, configurable individual analysis of data streams, based on wavelet transform for fault detection and use of recursive least squares for reconstruction of data, as is also discussed below. In conjunction with the user interface definition component 120, the data reconstruction component 122 can be used to reconstruct faulty data according to a selected type of operation. Example operations may include forward data reconstruction 124 and backward data reconstruction 126, as are further discussed below. In other examples, such as the single sensor data cleansing methods and systems discussed herein, a recursive least squares data reconstruction operation 128 may be used, such as the auto-regressive recursive least squares process discussed below in connection with FIGS. 42-51.

The computing system 102 can also include a communication interface 130 configured to receive data streams from the oil production facility 104, and transmit notifications as generated by the data processing framework 114, as well as a display 132 for presenting a user interface associated with the data processing framework 114. In various embodiments, the computing system 102 can include additional components, such as peripheral I/O devices, for example to allow a user to interact with the user interfaces generated by the data processing framework 114.

Referring now to FIG. 2, an example process 200 is illustrated for cleansing data in a data set is illustrated. The data set used in process 200 can be, for example, a collection of data streams from a data source, such as from the oil production facility 104 of FIG. 1.

In the embodiment shown, the process 200 generally includes monitoring performance of a particular set of dynamic data that can be included in one or more data streams (step 202). Those data streams can be monitored for performance, for example based on a principal component model. The model, for purposes of illustration, can represent a series of N samples for each of a vector of m sensors. Accordingly, a data matrix of samples can be depicted as:

XεR^{N×m}

In this arrangement, each row represents a sample x^{T}.

The matrix X is scaled to a zero-mean, and unit variance, for use in principal component analysis (PCA) modeling. The matrix X is then decomposed into a score matrix T and a loading matrix P by singular value decomposition (SVD), as follows:

X=TP^{T}+\tilde{X}

In this notation, T=XP contains l leading left singular vectors and the singular values, P contains l leading right singular vectors, and \tilde{X} is the residual matrix. As such, the columns of T are orthogonal and the columns of P are orthonormal. The sample covariance can therefore be depicted as:

$$S = \frac{1}{N - 1} {X}^{T} X$$

In the alternative, an eigen-decomposition can be performed on S to obtain P as the l leading eigenvectors of S and all eigenvalues are denoted as:

Λ=diag{λ₁,λ₂, . . . ,λₘ}

In this arrangement, the i^{th} eigenvalue can be related to the i^{th} column of the score matrix T as follows:

$${λ}_{i} = \frac{1}{N - 1} {t}_{i}^{T} {t}_{i} \approx var \{ {t}_{i} \}$$

This represents the sample variance of the i^{th} score vector. Additionally, the principal component subspace (PCS) is Sₚ=span {P} and the residual subspace (RS) Sᵣ is the orthogonal complement. The partition of the measurement space into PCS and RS is performed such that the residual space contains only tiny singular values corresponding to a subspace with little variability, i.e., is primarily noise.

In performing principal component analysis as discussed in further detail herein, a sample vector xεR^{m} can be projected on the PCS and RS, respectively, as \hat{x}ₖ=Ptₖ, where tₖ=P^{T}xₖ is a vector of the scores of l latent variables, with the residual vector being \tilde{x}ₖ=xₖ−\hat{x}ₖ=(I−PP^{T})xₖ.

In conjunction with the present disclosure, it is noted that a dynamic principal component analysis can be employed similarly to the arrangement discussed above, but with the measurements used to represent dynamic data from processes such as oil wells, or oil production facilities. In such cases, lagged variables may be used to represent the dynamic behavior of inputs to the model, thereby adjusting the method by which the model is built. Furthermore, in such cases, the measurement vector can be related to a score vector of fewer latent variables through a transfer function matrix. In this case, the measured variables are not characterized as input and output variables, but rather are related to a number of latent variables to represent their respective correlations. Assuming that zₖ is a collection of all variables of interest at time k, an extended variable vector can be defined as follows:

xₖ^{T}=[zₖ^{T},zₖ₋₁^{T} . . . z_{k-d}^{T}]

The principal component analysis scores can then be calculated as above, as follows:

tₖ=P^{T}[zₖ^{T},zₖ₋₁^{T} . . . z_{k-d}^{T}]^{T}

As a transfer function, this can be represented as tₖ=A(q⁻¹)zₖ. In this representation, A(q⁻¹) is a matrix polynomial formed by the corresponding blocks in P. The latent variables are linear combinations of past data with largest variances in descending order, analogous to a Kalman filter vector.

It is noted that monitored data can, in multivariate process monitoring generally include fault detection (step 204). Typically, squared prediction error (SPE) and/or the Hotelling's T² indices are used to control normal variability in RS and PCS, respectively. With respect to squared prediction error, an index can be used to measure the projection of a particular sample vector on the residual subspace, noted as SPE≡∥\tilde{x}ₖ∥²=∥(I−PP^{T})xₖ∥². In this illustration of SPE, \tilde{X}ₖ=(I−PP^{T})xₖ, and the process is considered normal if SPE is less than a confidence limit δ². When a fault occurs, the faulty sample vector includes a normal portion superimposed with the fault portion, with the fault making SPE larger than the confidence limit (and hence leading to detection of the fault).

Hotelling's T² index measures variations in PCS, namely T²=x^{T}PΛ⁻¹P^{T}x. When normal data follows a normal distribution, the T² statistic is related to an F-distribution, such that for a given confidence level β, the T² statistic can be considered as:

$${T}^{2} \leq {T}_{β}^{2} ≡ \frac{l ( N - 1 )}{N - l} {F}_{l , N - l , B}$$

If there is a sufficiently large number of data points N, the T² index can be approximated under normal conditions with a distribution with 1 degrees of freedom, or T²≦χₗ².

In the context of the present disclosure, a detectable fault will have an impact on the measurement variable that will cause it to deviate from a normal case. While the source of the fault may not be known, its impact on the measurement may be isolable from other faults. As noted herein the measurement vector of the fault free portion can be denoted as z*ₖ which is unknown when a fault has occurred. However, the sampled vector zₖ, corresponding to the received sample measurement, is illustrates as zₖ=z*ₖ+ξᵢfₖ. In this arrangement, ∥fₖ∥ corresponds to a magnitude of the fault, and can change over time depending on the development of the fault over time. The fault direction matrix ξᵢ can be derived from modeling the fault case as deviation from normal operation, or can alternatively be extracted from historical data.

Once a fault is detected, it can be the case that a particular sensor or incoming data stream contributes to the fault more than others, even though it may not be apparent from values received from that data stream. As such, a fault identification operation (step 206) can be performed to identify a particular sensor or data input that presents the greatest contribution to the fault. In example embodiments, a reconstruction-based contribution (RBC) of each variable can be determined to detect the source of a particular fault. This is the case for either forward or backward data reconstruction, as are explained herein. Although limited by a confidence limit of the reconstruction, use of the RBC-based contribution and fault identification analysis allows for multiple input values to be detected as a source of faults, or only one such input value.

In example embodiments, the fault identification of step 206 can be performed by using an amount of reconstruction along a variable direction as an amount of contribution of the variable to the fault detection index that is reconstructed. For example, when a fault in a data input i (e.g., a sensor) is detected at time k and no fault is detected prior to time k, a fault detection index violates a control limit because the sample at time k contains the fault. As such, reconstruction is performed for each sensor, as noted in step 208 of FIG. 2. Accordingly, a fault contribution at time k can be expressed as:

xₖ=x*ₖ+Ξᵢ_{₀}fₖ

Furthermore, the reconstruction-based contribution can be defined as an amount of reconstruction along the direction of the faulty sensor, as follows:

RBCᵢ^{SPE}=∥\tilde{Ξ}ᵢf_{k,i}^{T}∥²=xₖ^{T}\tilde{Ξ}ᵢ\tilde{Ξ}ᵢ⁺xₖ

Accordingly, to identify which sensor is faulty, a comparison of fault contributions is made for each input i, and those fault contributions are compared. The reconstructed SPE index along the true fault direction therefore has a relation as follows:

SPE(x_{k,i}_{ₒ}^{r})≦SPE(x*ₖ)≦δ²

When the true fault direction is used for reconstruction, a reconstructed SPE is therefore brought within a normal control limit.

Accordingly, in a general fault identification process using the RBC-based fault identification as discussed herein, at a time where the SPE is outside of a control limit, the RBC is determined for each input data stream (e.g., sensor), and the sensor is identified having the largest RBC. A calculated replacement value is then formulated and used to replace the data value for the input for which an error is detected (e.g., as in step 208).

In alternative embodiments, a general fault detection index can be used for fault reconstruction and identification. Furthermore, other types of fault isolation could be used, such as use of fault detection statistics, reconstructed indices, discrimination by angles, pattern matching to existing fault data, or other faulty input isolation techniques.

Once a fault is detected, the faulty data can be reconstructed using a variety of techniques, including, as discussed further herein, forward and/or backward data reconstruction based on the squared prediction error (step 208). This can be performed, for example, using the forward or backward data reconstruction operations 124, 126, respectively, of FIG. 1.

In particular, a reconstructed sample vector can be expressed as the actual sample minus the erroneous component, or zₖ^{r}=zₖ+ξᵢ fₖ^{r}, with fₖ^{r} representing an estimate of the actual fault magnitude. Correspondingly, the fault free portion of the signal corresponds to zₖ^{a}=(ξᵢ^{perp})zₖ=(ξᵢ^{perp})^{T}z*ₖ, and the fault portion of the vector corresponds to zₖ^{f}=εᵢ^{T}zₖ.

In an example of the above arrangement, assuming there is an array of 5 sensors, with sensors 2 and 4 having missing values, includes ξᵢ columns of an identity matrix, namely:

$${ξ}_{i} = [ \begin{matrix}0 & 0 \\ 1 & 0 \\ 0 & 0 \\ 0 & 1 \\ 0 & 0\end{matrix} ] ; {ξ}_{i}^{perp} = [ \begin{matrix}1 & 0 & 0 \\ 0 & 0 & 0 \\ 0 & 1 & 0 \\ 0 & 0 & 0 \\ 0 & 0 & 1\end{matrix} ]$$

Accordingly, the fault vector is represented as zₖ^{f}=[z_{2,k}, z_{4,k}]^{T}, and the non fault vector is represented as zₖ^{a}=[z_{1,k}, z_{3,k}, z_{5,k}]^{T}; reconstruction is therefore generating zₖ^{f} from zₖ^{a}.

To reconstruct faulty data from non-faulty data (i.e., reconstructing zₖ^{f} from zₖ^{a}), a fault ξᵢ at time k₀ and a number of subsequent time intervals, a dynamic PCA process is performed using fault direction ξᵢ such that the effect of the fault is eliminated. In particular, in some embodiments, a forward data reconstruction technique can be used.

To perform the forward data reconstruction technique, it is assumed that a first entry zₖ₀ in xₖ₀ includes a fault in the direction ξᵢ. Accordingly, an optimal reconstruction from complete data up to time k₀−1 and partial data at k₀ is made.

Assuming a start variable j that is initialized at 0, j can be incremented, and at time k₀+j, an optimal reconstruction of zₖ₀₊ⱼ^{r} from complete or previously reconstructed data up to k₀+j−1 and partial data at k₀+j. This process is repeated, including incrementing j, until all faulty samples are reconstructed.

As applied to the vector xₖ, the fault model can be represented as xₖ=x*ₖ+Ξᵢfₖ, where Ξᵢ=|ξᵢ^{T} 0 . . . 0|^{T}. Based on this, it is only the first entry zₖ of xₖ that contains a fault and requires reconstruction, using reconstructed sample vector xₖ^{r} as follows:

xₖ^{r}=xₖ−Ξᵢfₖ^{r}

To perform reconstruction, fₖ^{r} is found, such that the reconstructed squared prediction error (SPE(xₖ^{r})=∥\tilde{x}ₖ^{r}∥²=∥\tilde{x}ₖ−Ξₖfₖ^{r}∥²) is minimized, where \tilde{Ξ}ᵢ=(I−PP^{T})Ξᵢ. This can be performed, for example, based on a least squares estimate of the fault magnitude as follows:

fₖ^{r}=\tilde{Ξ}ᵢ⁺\tilde{x}ₖ=\tilde{Ξ}ᵢ⁺xₖ

This leads to a reconstructed measurement vector:

xₖ^{r}=xₖ−ΞᵢΞᵢ⁺xₖ=(I−ΞiΞi+)xₖ

Residual data space is illustrated as: \tilde{x}ₖ^{r}=(I−\tilde{Ξ}ᵢ\tilde{Ξ}ᵢ⁺)xₖ. Accordingly, the reconstructed squared prediction error corresponds to ∥\tilde{x}ₖ^{r}∥²=∥\tilde{x}*ₖ∥² which results in entire removal of the fault following reconstruction. For the missing entries in zₖ, these entries are replaced with zeroes; accordingly, the reconstructed missing entries are calculated from:

zₖ^{f,r}=ξᵢ^{T}zₖ^{r}=zₖ^{f}−Ξᵢ⁺xₖ=−Ξᵢ⁺xₖ

The above squared prediction error eliminates the effect of the error in residual space, while leaving principal component variations unchanged. Accordingly, in some embodiments, the magnitude of the T² index is penalized while minimizing the SPE, leading to a global index based reconstruction:

Φ(xₖ^{r})=SPE(xₖ^{r})+μT²(xₖ^{r})=(xₖ^{r})^{T}Φxₖ^{r}

In the above, Φ=I−PP^{T}+μPΛ⁻¹P^{T}. Furthermore, the least-squares reproduction of this, based on the global index, is provided by:

fₖ^{r}=(Ξᵢ^{T}ΦΞᵢ)⁻¹Ξᵢ^{T}Φxₖ

The forward data reconstruction based on the global index follows the same procedure as discussed above, based on SPE.

It is noted that, in eliminating the fault along the fault direction, normal variations along the fault direction are also eliminated. If normal variations are very large in the PCS, in some embodiments the T² index may be excluded.

In the case of forward data reconstruction, it is generally required that the initial portion of the data sequence are normal for at least d consecutive time intervals so that only zₖ in xₖ is missing or faulty. If this is not the case, one can reconstruct the missing or faulty data backward in time.

In the case of backward data reconstruction, the sequence of data that can contain faults, zₖ, can have faults ξᵢ with a direction occurring at time k₀ and a number of previous time intervals. The DPCA model can in this case again be used along the fault direction ξᵢ such that the effect of the fault is eliminated. This backward data reconstruction reconstructs zₖ₀₋ⱼ^{r} (a time from which a fault occurs, backwards in time) based on actual data from z_{k0-j+d}^{r} to zₖ₀₋ⱼ₊₁, and any available data at zₖ₀₋ⱼ^{r}. In particular, backward data reconstruction includes obtaining an optimal reconstruction zₖ₀^{r} from complete data from k₀+1 and partial data at k₀. Index j is incremented, and at time k₀−j, zₖ₀₋ⱼ^{r} is reconstructed from actual or previously reconstructed data at k₀−j+1, and available partial data at k₀−j. This process is repeated until all faulty samples are reconstructed.

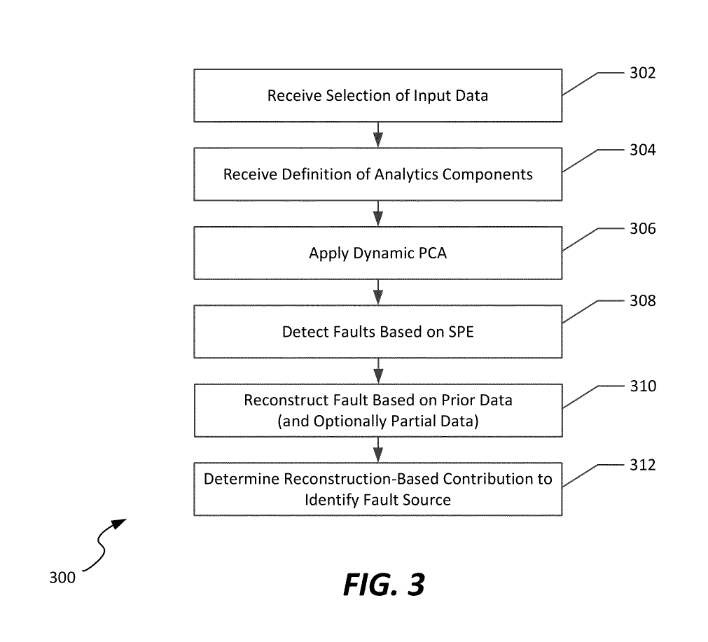

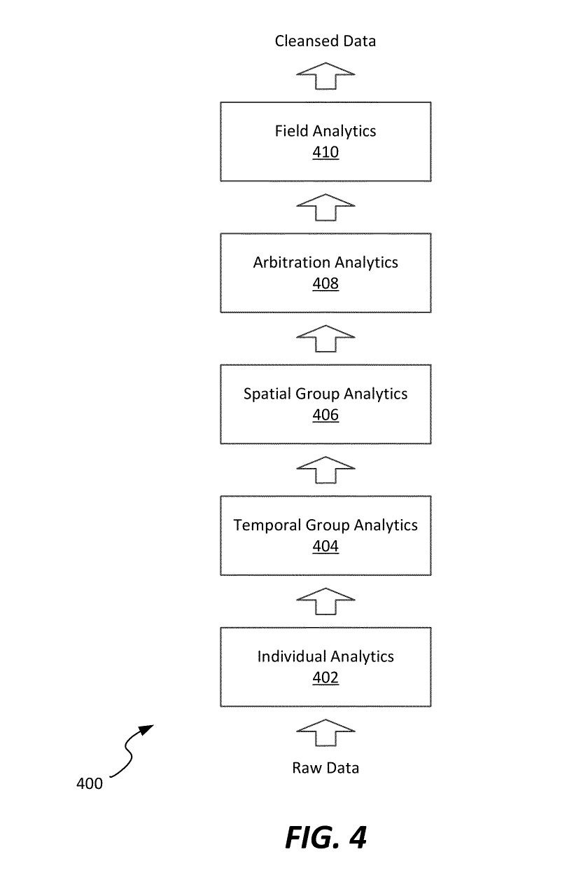

Based on the above, FIG. 3 illustrates a particular embodiment of a method 300 of the present disclosure in which dynamic data can be reconstructed. The method 300 represents a particular application of data reconstruction that is implemented within a scalable data processing framework as discussed herein. In particular, the method 300 can use the modules and user interfaces illustrated in FIGS. 4-11, below, for configurably providing error detection and associated dynamic data reconstruction.

In the embodiment shown, the method 300 includes receiving a selection of one or more input data streams at a data processing framework (step 302). This can include, for example, receiving a definition, from a user at a user interface, of one or more input data streams from an oil production facility. The method 300 can also include receiving a definition of one or more analytics components at the data processing framework (step 304). This definition can include selection of one or more analytics components, and definition of analytics component features to be used, as selected from a pipelined analysis arrangement (e.g., as illustrated in FIG. 4, below). This can include, for example, selection for analysis of a data stream including data collected from a sensor in the case of a single input data cleansing method using wavelet transforms, or selection of a plurality of data streams for use in connection with the DPCA-based systems discussed herein. It can also include, for example, receiving one or more configuration parameters from a user that assist in defining the operations to be performed. For example, this can include receiving thresholds from a user that define fault thresholds or other thresholds at which data reconstruction will occur (or a type of data reconstruction to apply).

The method 300 generally includes applying a principal component analysis to the one or more input data streams that were selected in step 302, and in particular, applying a dynamic principal component analysis (step 306). In such embodiments, measured variables (e.g., measurements included in the defined input data streams) are not characterized as input and output variables, but rather are related to a number of latent variables that represent their respective correlations, and are correlated to a window of previous observations of the same features. The method 300 also includes detecting a fault in the one or more input data streams (step 308). This fault detection can be, for example, based on a comparison between a predetermined threshold and a squared prediction error. It can also be based on a variation in principal component subspace generated based on the dynamic principal component analysis.

Optionally, the method 300 can further involve identifying and determining an input that contributes most to the fault (step 310), for example by using the RBC method discussed above in connection with FIG. 2.

The method 300 can additionally involve reconstructing the fault that occurs in the data of the data streams (step 312). This can include reconstructing the fault based on data collected prior to occurrence of the fault and optionally partial data at the time of the fault, such as may be the case in forward data reconstruction as discussed above. In alternative embodiments, a backward data reconstruction could be used. Furthermore, in some embodiments, the fault can be removed from the measured value, leaving a corrected or “reconstructed” measurement. In still other embodiments, a single input data cleansing operation can employ such data reconstruction techniques.

Referring now to FIGS. 4-11, various architectural features of a scalable data processing framework are discussed in which the above DPCA and data reconstruction techniques can be employed. In an example embodiment, a scalable data processing architecture 400 can include a plurality of data cleansing modules, of which one or more could include data reconstruction features. In an example embodiment, an Individual Analytics (IA) module 402, Temporal Group Analytics (TGA) module 404, Spatial Group Analytics (SGA) module 406, Arbitration Analytics (AA) module 408, and Field Analytics (FA) module 410, are shown all serialized in a pipeline.

In example embodiments, one or more of the data cleansing modules 402-410 can be arranged to provide the fault detection, identification, and reconstruction features discussed above. In an example embodiment, the fault detection, identification, and reconstruction features discussed above are included in one or both of the Temporal Group Analytics (TGA) module 404 and the Spatial Group Analytics (SGA) module 406.

It is noted that, in some embodiments of the architecture 400, the order/sequence of applying modules 402-410 is fixed; however, in other embodiments, the modules 402-410 can be executed in parallel. Furthermore, in some embodiments, the combination of modules applied to a particular data stream is configurable. Moreover, the operators applied within each module are also configurable/programmable. The operators can also be implemented in a number of ways; for example, declarative continuous queries, or user-defined functions or aggregates could be used. In comparison, the declarative continuous queries have less functionality, but more flexibility, than the user-defined functions.

In some embodiments, the Individual Analytics (IA) module 402 includes operators that operate on single data values in input data streams. These operators can be used to clean and/or filter individual data items only based on the value of the item itself. Example IA operators can include simple outlier detection (e.g., exceeding thresholds), or raw data conversion (e.g., heat sensors output data into voltages, which must be converted to temperature by considering calibration of that sensor). Other operators could also be included in the IA module 402 as well. For example, operators could be included that provide for single input data cleansing, as discussed below.

In example embodiments, the Temporal Group Analytics (TGA) module 404 includes operators that operate on data segments in input data streams. These operators can be configured to clean individual data values as part of a temporal group of values by considering their temporal correlation. The TGA operators can be implemented using window-based queries. Example TGA operators include generic temporal outlier detection operators and temporal interpolation for data reconstruction, as is discussed in detail above. Although the term module is used herein, this disclosure is not limited to the use of modules, however may be implemented as necessary by one of ordinary skill in the art.

In example embodiments, the Spatial Group Analytics (SGA) module 406 includes operators that operate on data values from multiple data streams. These operators clean individual data values as part of a spatial group of values by considering their spatial correlation, and can be implemented, in some embodiments, using window join queries. One example SGA operator is a generic spatial outlier detection (e.g., within a spatial granule this operator can compute the average of the readings from different sensors and omit individual readings that are outside of two deviations from the mean).

In example embodiments, the Arbitration Analytics (AA) module 408 includes operators that operate on data values from multiple spatial granules to arbitrate the conflicting cleansing decisions. Example AA operators include conflict resolution and de-duplication operators.

In example embodiments, the Field Analytics (FA) module 410 includes operators that operate on data values from multiple stream sources of different modalities (e.g., heat and pressure). These operators can be used to consider correlation between data values of distinct modality and leverage this correlation to enhance data cleansing results. An example FA operator provides outlier detection by cross-correlation of data streams.

The data cleansing modules 402-410 operate on the data in sequence, with disjoint and covering functionality; i.e., they each focus on a specific set of data cleansing problems, and are complementary. In sequence, the modules 402-410 focus on finest data resolution (single readings) to coarsest data resolution (multiple sensors and various modalities). In turn, each module implements one or more data cleansing “operators”, all focusing on the type of functionality supported by the corresponding module.

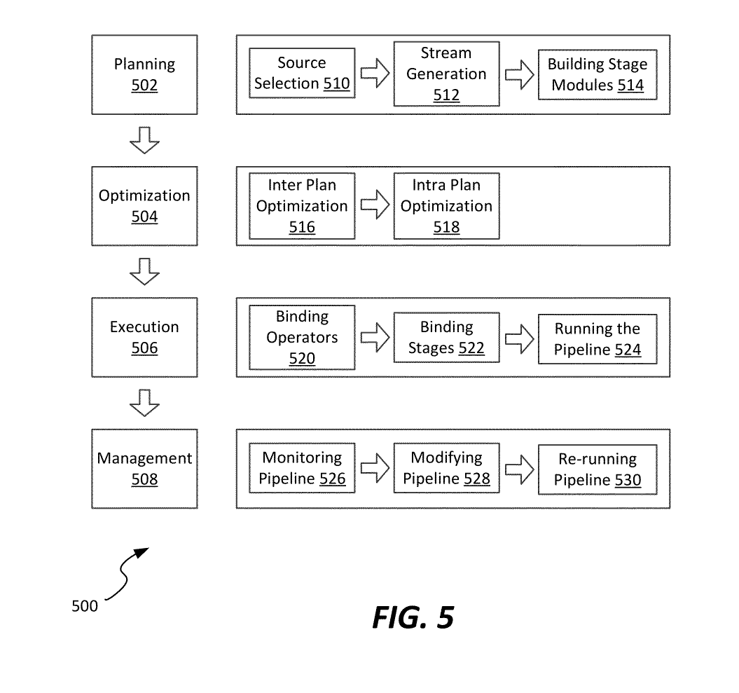

Referring now to FIG. 5, a system 500 implementing the architecture 400 is illustrated, considering specific requirements and capabilities of such a scalable platform. In particular, a management framework and associated stream data processing engine are used to create a data processing framework, such as data processing framework 114 of FIG. 1.

In the embodiment shown, the system 500 includes four stages, including a planning stage 502, an optimization stage 504, an execution stage 506, and a management stage 508. In the planning stage 502, the system includes source selection 510, generation of data streams 512, and building one or more stage modules 514. To accomplish these tasks, the system 500 guides the user to interactively plan a data cleansing task by configuring the operators and modules, resulting in a directed acyclic graph of operators and tuned parameters that defines the flow of the raw data among the operators.

In the optimization stage 504, the graph of operators is reconfigured such that the functionality of the graph stays invariant, while the performance is optimized for scalability. This involves addressing a number of data streams and the rate of the data in each stream, relative to both inter-plan optimization 516 and intra-plan optimization 518, based on the available computing resources on computing system 102.

In the execution stage 506, the optimized plan is enacted by binding the corresponding operators 520, binding the associated stages 522, and executing the plan 524 using the pipelined modules. Finally, in the management stage 508, the system 500 allows a user to manage the executed tasks, for example to monitor the pipeline modules 526, modify the pipeline as needed 528, and re-run the pipeline 530, for example based on the modifications that are made.

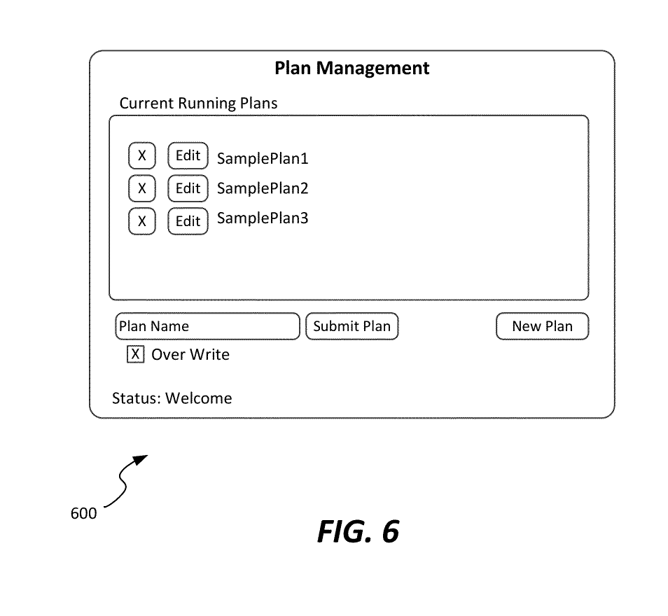

Referring now to FIGS. 6-8, graphical user interfaces that can be generated by the system 500 are shown, and which can be used by a user to manage and define data cleansing operations. For example, in FIG. 6, a graphical user interface 600 is shown that is generated by the system 500, within the framework 400, and which allows a user to manage a modular, scalable data cleansing plan that includes data reconstruction as discussed above. The user interface 600 can be, for example, implemented as a web-based tool generated or hosted by a computing system, such as system 102 of FIG. 1, thereby allowing remote definition of data cleansing plans. In various embodiments, the graphical user interface can be implemented in a variety of ways, such as using PHP, Javascript (client-side), or a variety of other types of technologies. The graphical user interface 600 presents a number of pre-defined data cleansing plans, and allows a user to view, delete, edit, or otherwise select an option to define a new data cleansing plan as well.

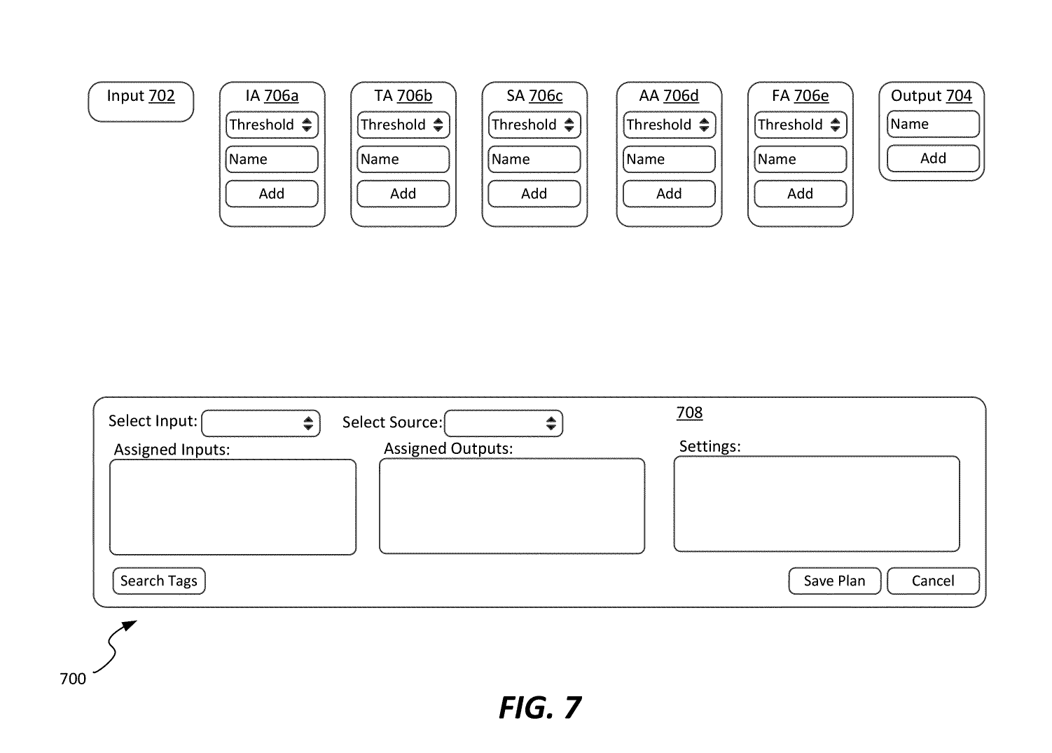

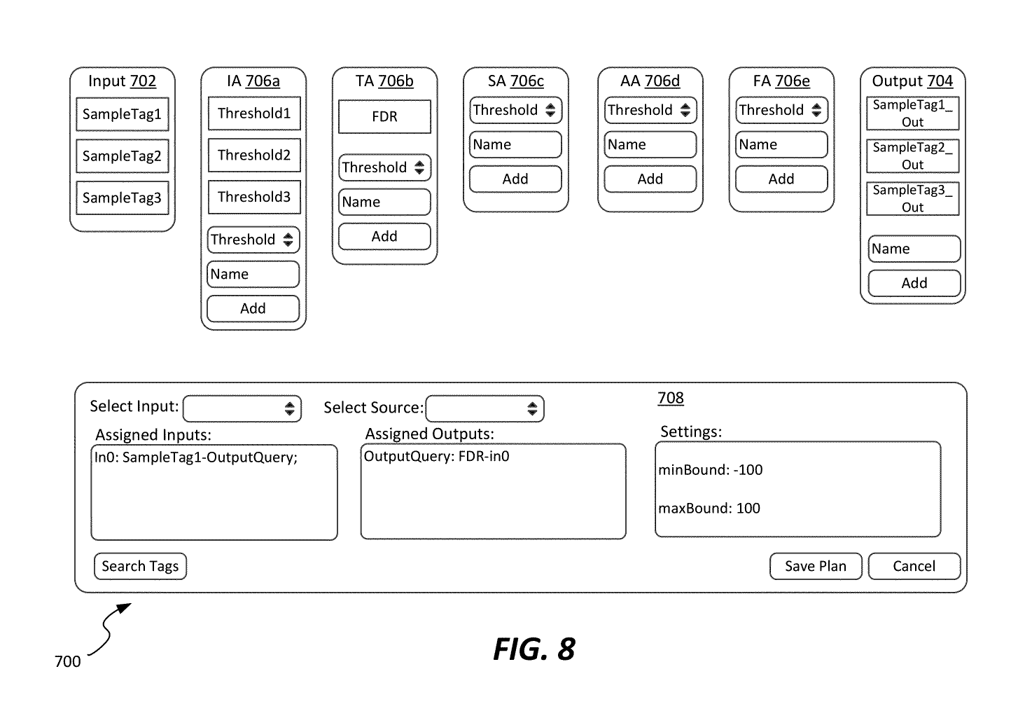

FIGS. 7-8 illustrates a further example user interface 700 of the system 500, which allows the user to define specific operations to be performed as part of a data cleansing plan. In particular, FIG. 7 shows the generalized user interface 700, while FIG. 8 shows the interface with a sample data cleansing plan developed and capable of being edited thereon.

In the user interface 700, an input definition region 702 and output definition region 704 allow a user to define input and output tags for the plan to be developed. A user can select the desired input tags by searching and filtering the tags based on the tag attributes (e.g., location). For each input added to the plan, a corresponding output tag can be automatically added; however, the list of the output tags is editable (tags can be added or deleted by the user on demand).

Once the desired lists of inputs and outputs are specified for the plan, a user can add as many different operators as needed from any of the five modules, illustrated in FIG. 4, using corresponding regions 706a-e. While an operator is being added to the plan, it can also be configured by setting one or more operator-specific parameters using the pane 708 shown at the bottom of the interface. Finally, input and output sets for the operators can be interconnected by simply clicking on the corresponding operators that feed them or are fed by them, respectively. Once a plan is finalized, the user can save the plan and submit the plan for execution by the core engine. In the particular example shown, a plan that includes forward data cleansing in region 706b is illustrated.

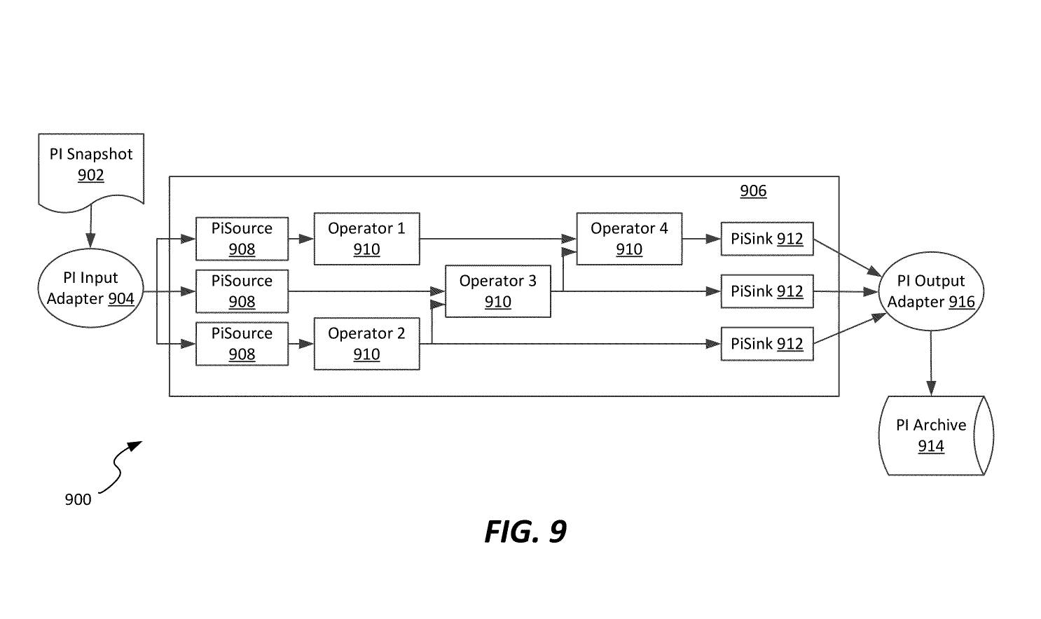

Referring now to FIGS. 9-11, data structures are illustrated for routing input data streams through the data processing components of the framework 400, based on defined operators in a data cleansing plan as defined using the user interfaces of FIGS. 6-8. In the embodiment shown, input data, in the form of a data snapshot 902, is received at an input adapter 904 and fed to a processing engine 906. The input data can be received from a time-series database 916, with data from each of a plurality of data streams managed under a unique tag name. The processing engine applies the defined data cleansing plan to the data, based on one or more sources (defined input tags) 908, operators 910 (as defined in the user interface, and including forward/backward data reconstruction), and sinks (defined output tags 912). The data streams, once processed, are returned to the database 914 via an output adapter 916.

In the example embodiment shown in FIG. 9, each data cleansing plan can use only a single input adapter 904. The input adapter 904 reads the data coming in from multiple streams and groups them into an aggregated data stream and feeds it to the engine 906. The running operators 910 often do not require all the data we are reading from the PI Snapshot. A source module 906 (depicted as “PiSource”) is responsible for extracting the specific data that the operators require from the super-stream.

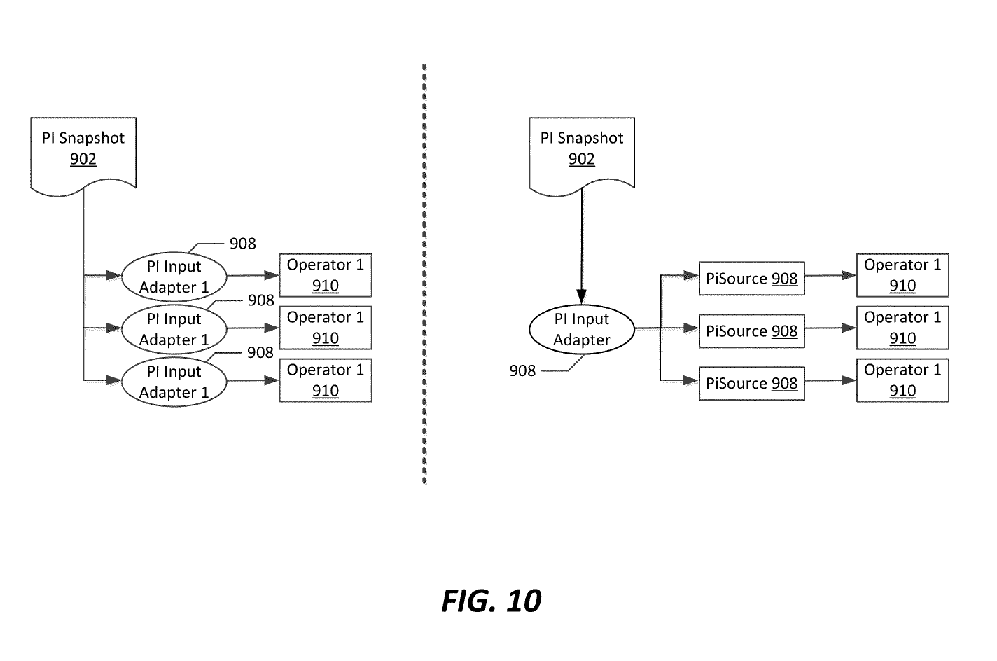

As shown in design alternatives illustrated in FIG. 10, two alternative arrangements are shown, in which either (1) a single adapter is used for multiple data streams and associated operators 910, or multiple adapters 904 are used, with one per specific data stream. However, it is noted that in some embodiments, adapters 904 can demand substantial system resources. By using only one input adapter to read all input data, although filtering the data is required, the use of system resources is optimized. This significantly improves the scalability of the system. A similar design arrangement holds for output adapter design.

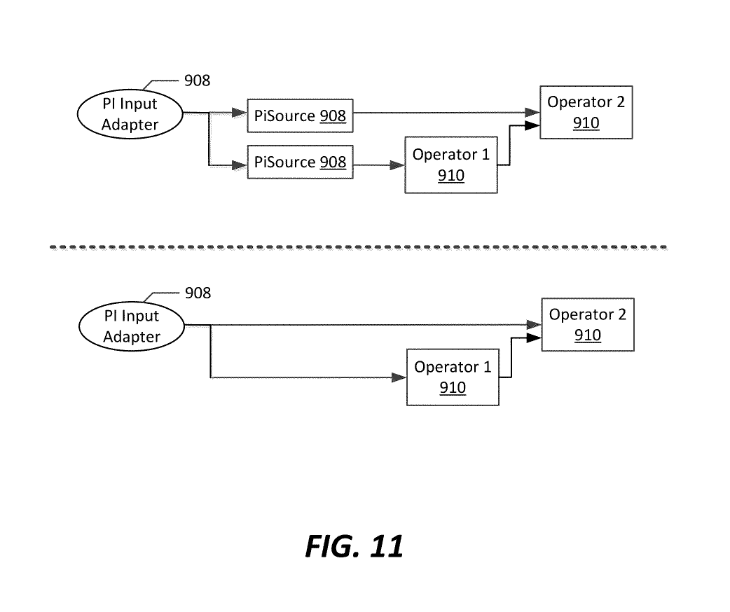

Referring to FIG. 11, it is noted that the sources 908, or input stream interfaces, operate as a universal interface, and can seamlessly read data either from the output of another operator or from the output of another source 908. Accordingly, FIG. 11 illustrates design alternatives with and without the source module 908, which complicates implementation of the operators 910 since the operators receive all types of stream data and must each parse the data individually.

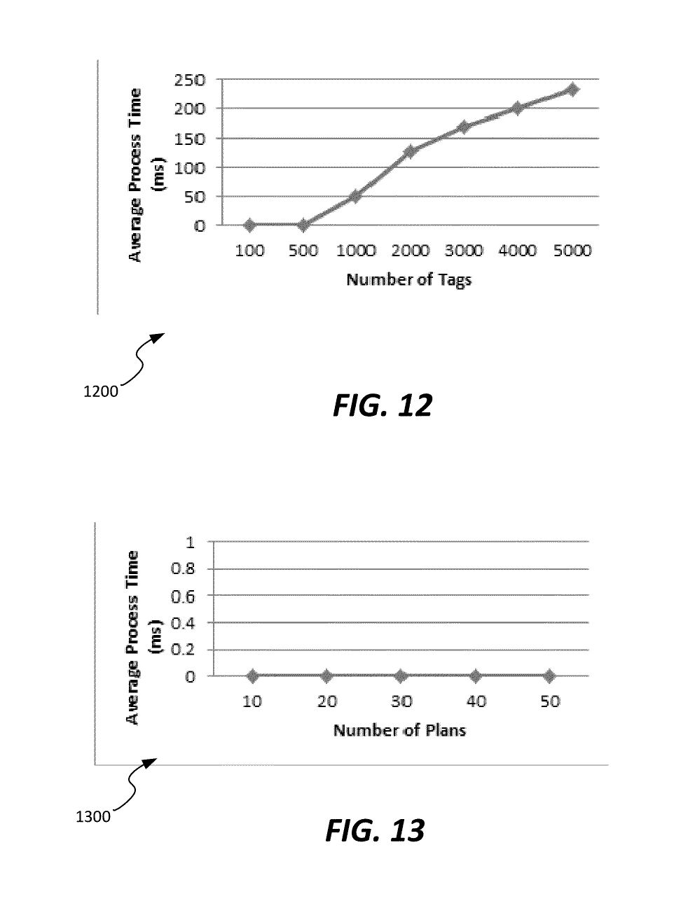

Referring now to FIGS. 12-13, graphs 1200, 1300, respectively, of experiments performed using the systems of FIGS. 4-10 are shown in which scalability of the systems is illustrated. In particular, in the experiments performed, a set of randomly-generated tags and readings were used.

In FIG. 12, the graph 1200 illustrates scalability of the overall framework as related to a number of input tags, which represent input data streams or data sources to be managed by the framework. In particular, processing time of each data item received from a tag was measured by recording an entry time at the snapshot 902 of FIG. 9, and an exit time for storage of data in database 914 of FIG. 9.

In the illustration shown, although the complexity of the algorithms/operators applied to the data items affects the processing time of the data item, throughout this experiment the same data cleansing operators were applied to all data items to isolate the scalability feature as the only standing variable. As seen, when up to 5,000 tags are used, process time remains below 250 ms. Furthermore, with fewer than 500 tags, the process time for data items remains negligible.

In FIG. 13, the graph 1300 shows scalability of the framework as the number of simultaneously running plans grows. In the experiment run to generate graph 1300, a plan with 100 input tags is used, and multiple instances of that same plan are executed, while measuring the processing time for the input data items. As illustrated, the overhead of adding new plans is negligible.

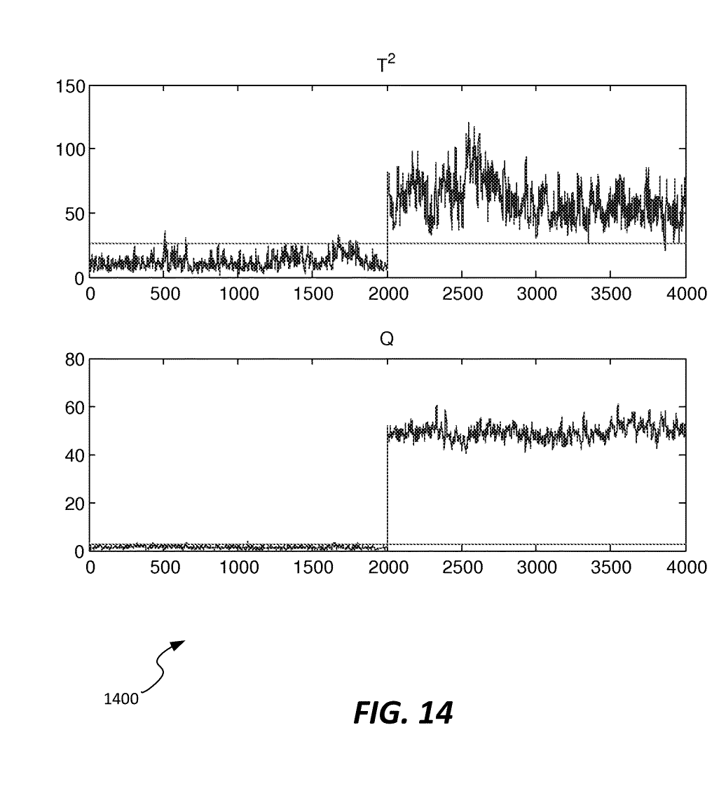

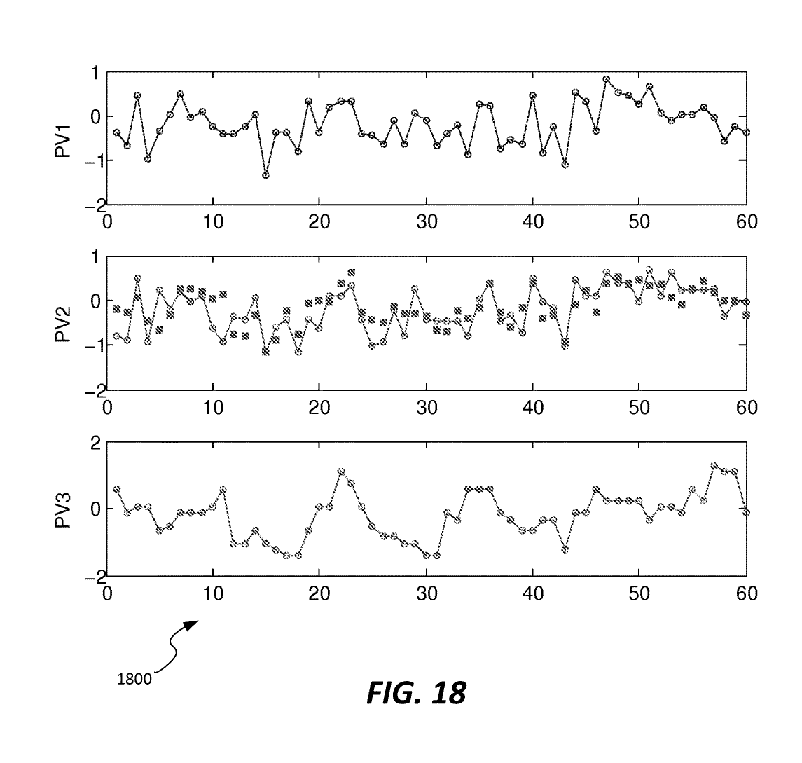

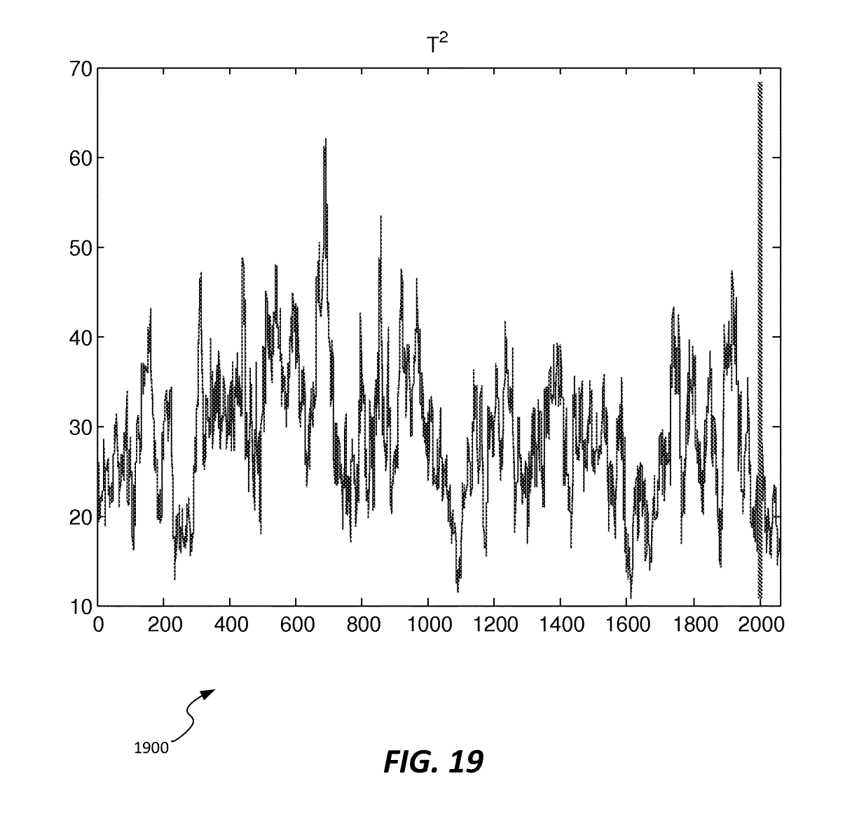

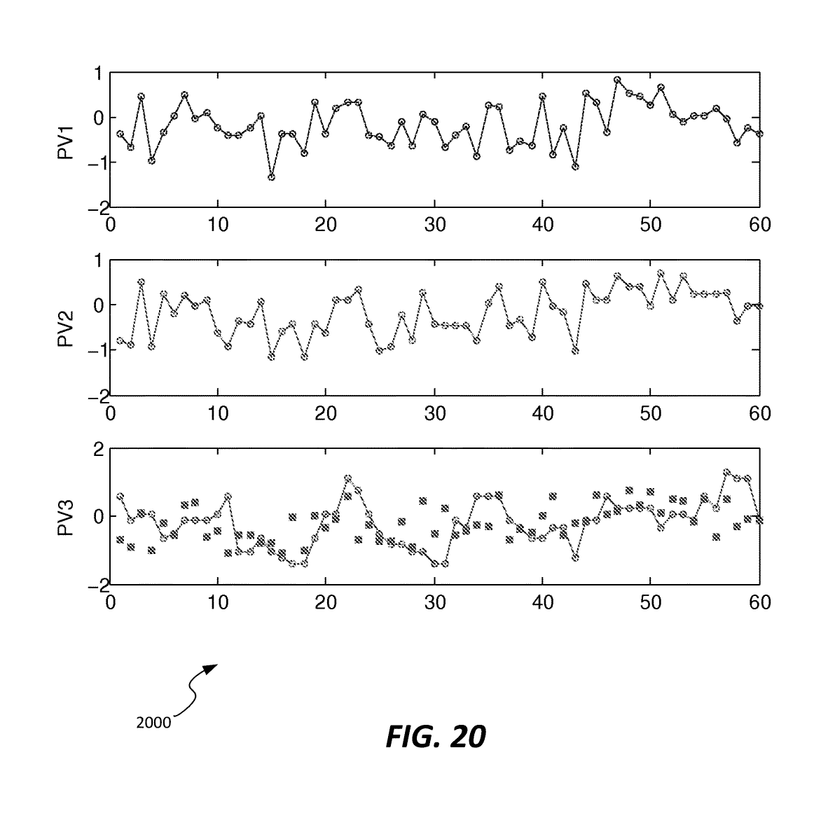

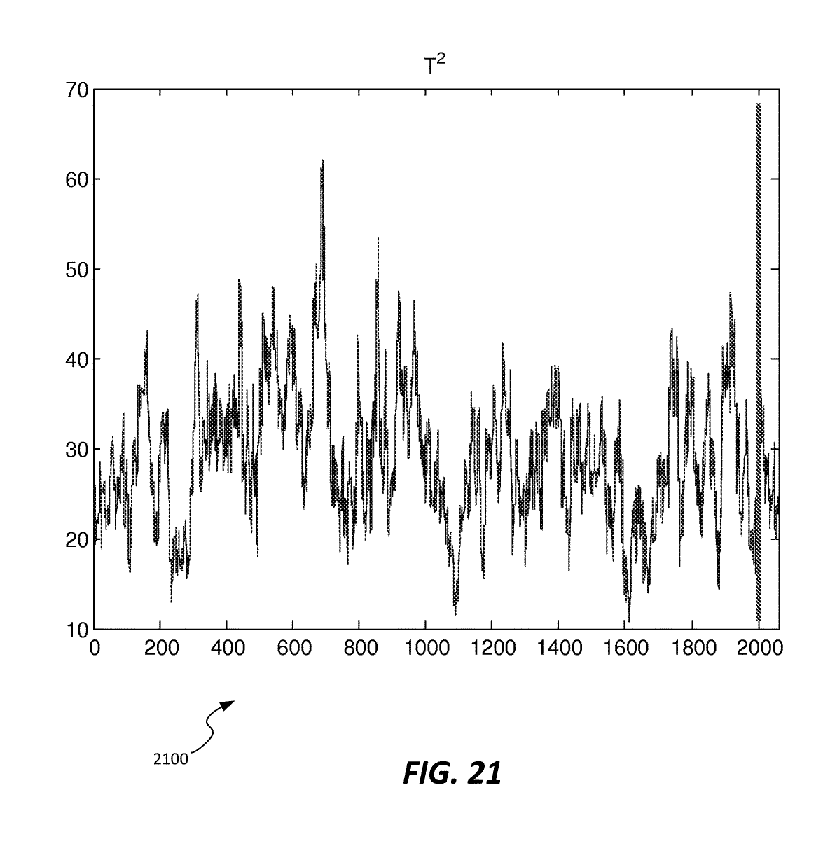

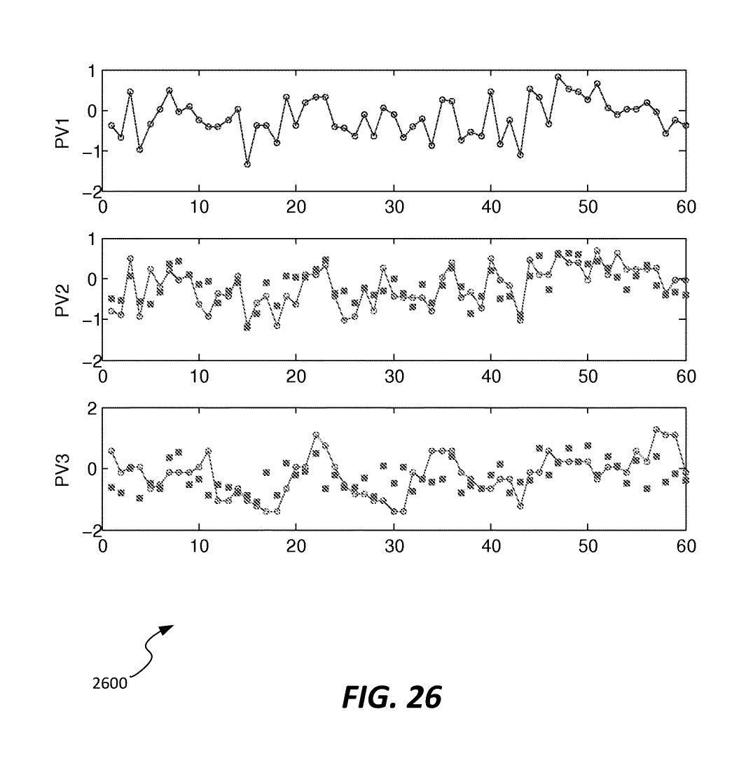

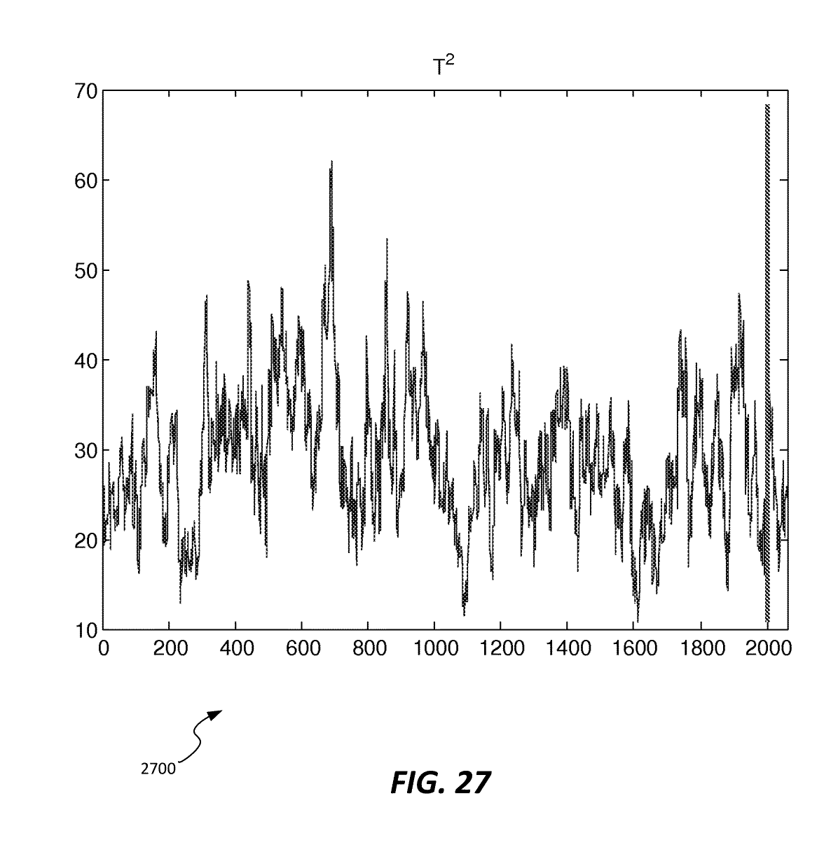

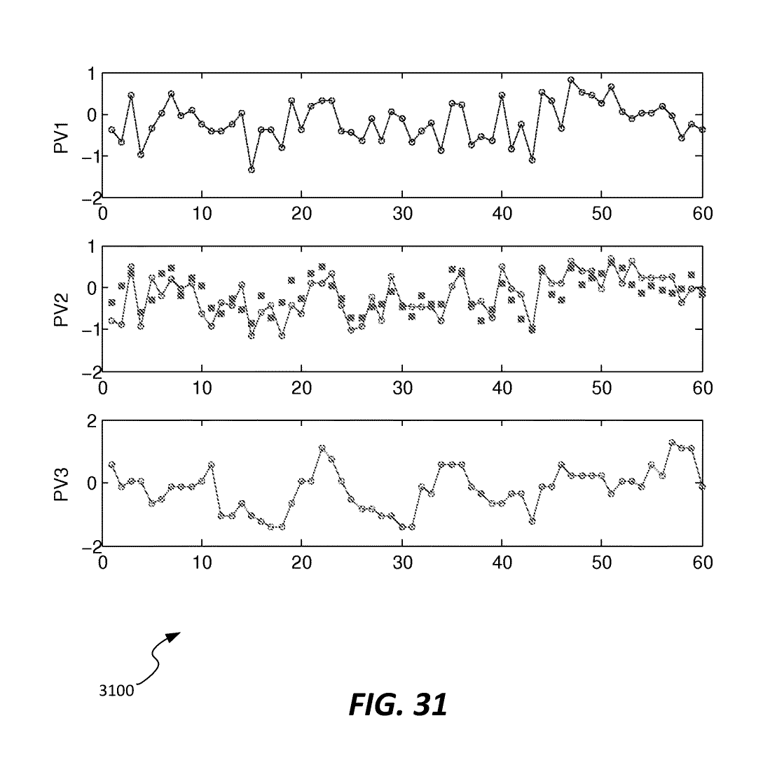

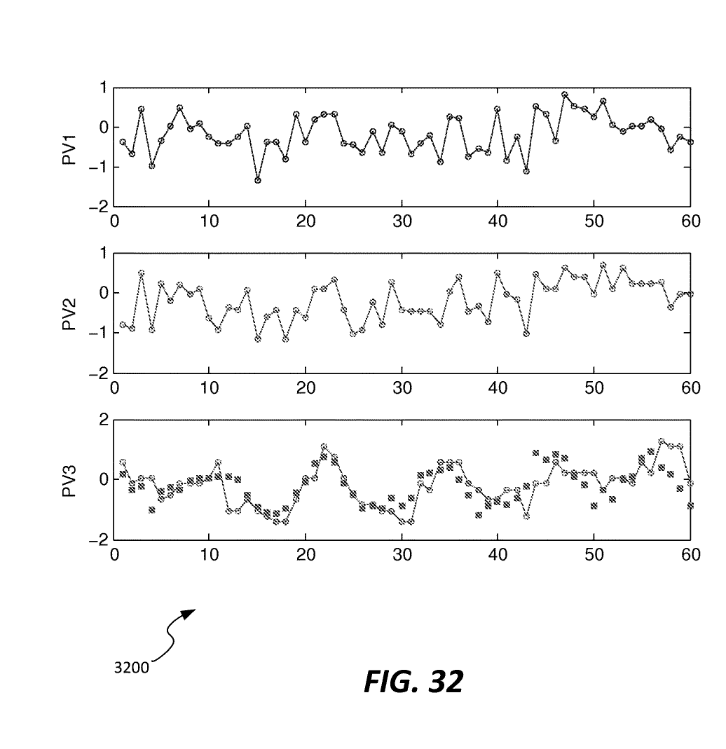

Referring now to FIGS. 14-36, example experimental results are shown for different types of errors that are observed in a system under test within the framework of FIGS. 4-11, and using the methods and systems described above in connection with FIGS. 1-3.

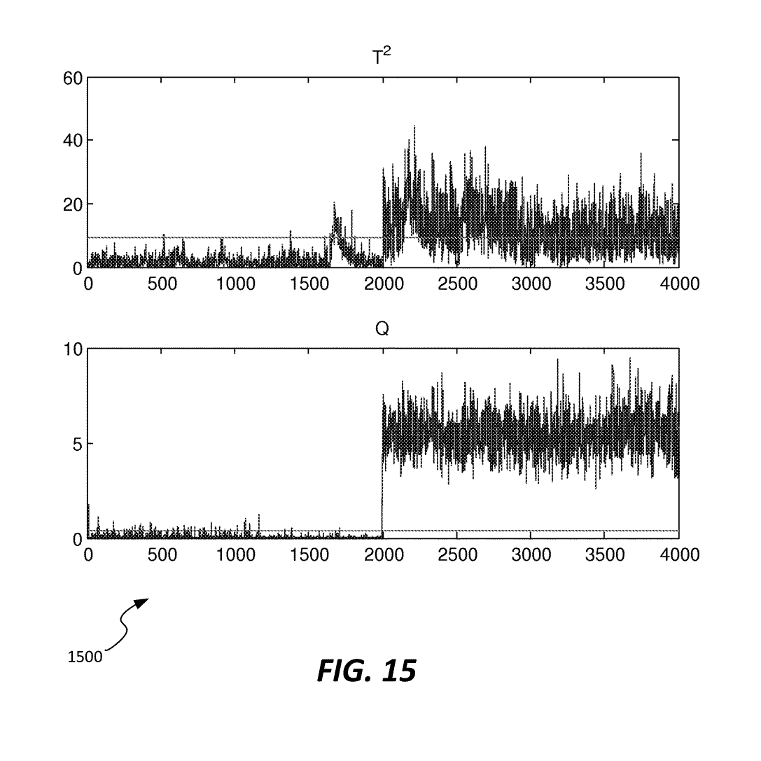

In FIGS. 14-15, example charts 1400, 1500, respectively, are depicted that show different types of principal component analysis of a step fault that occurs in a system, according to example embodiments. In particular, chart 1400 of FIG. 14 shows use of dynamic principal component analysis as discussed above, while chart 1500 of FIG. 15 shows standard principal component analysis. In particular, the dynamic principal component analysis of FIG. 14 has a T² and Q value (representing fault detection rates) of 100% m while standard principal component analysis shows a fault detection rate T² of 59%.

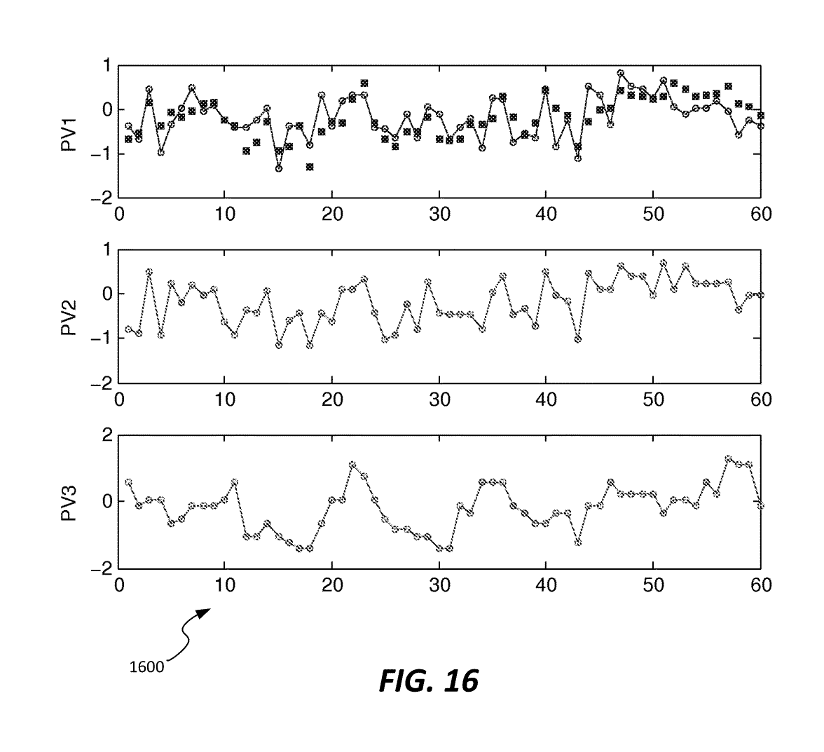

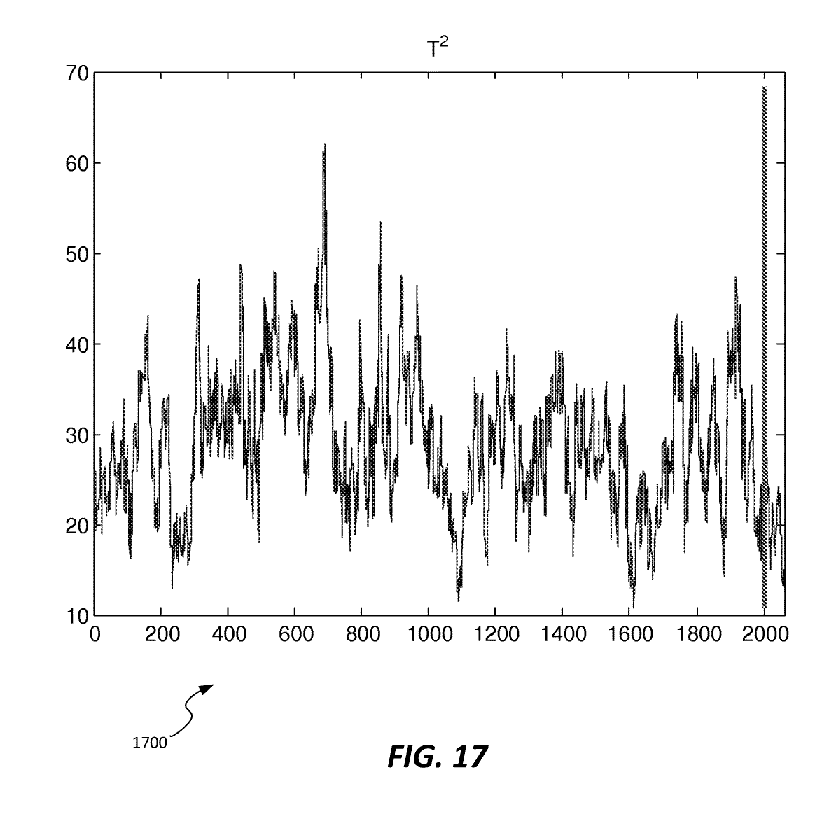

Referring to FIGS. 16-29, example experimental results for forward data reconstruction are shown. In particular, forward data reconstruction based on squared prediction error (SPE) as discussed above is performed.

In running the experiments illustrated in FIGS. 16-29, a training process is performed in which one sensor at a time (of three sensors) is allowed to go missing, and 2000 data points are reconstructed using the forward data reconstruction procedure. The mean squared error of reconstruction is then calculated. This is then repeated for each permutation of missing sensors, and an averaged mean squared error is calculated. The best number of principal components corresponds to the smallest averaged mean squared error.

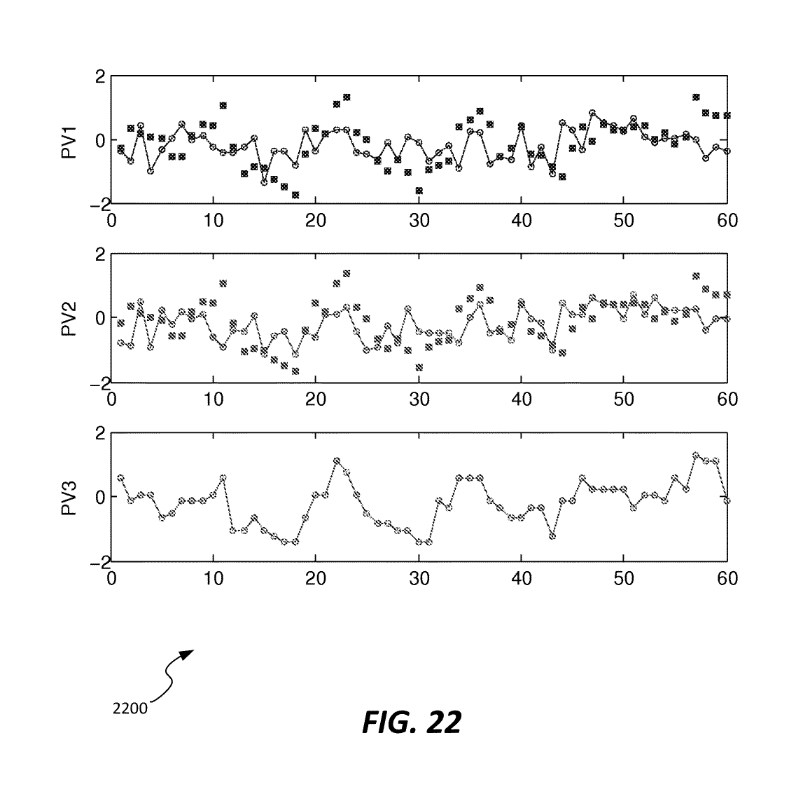

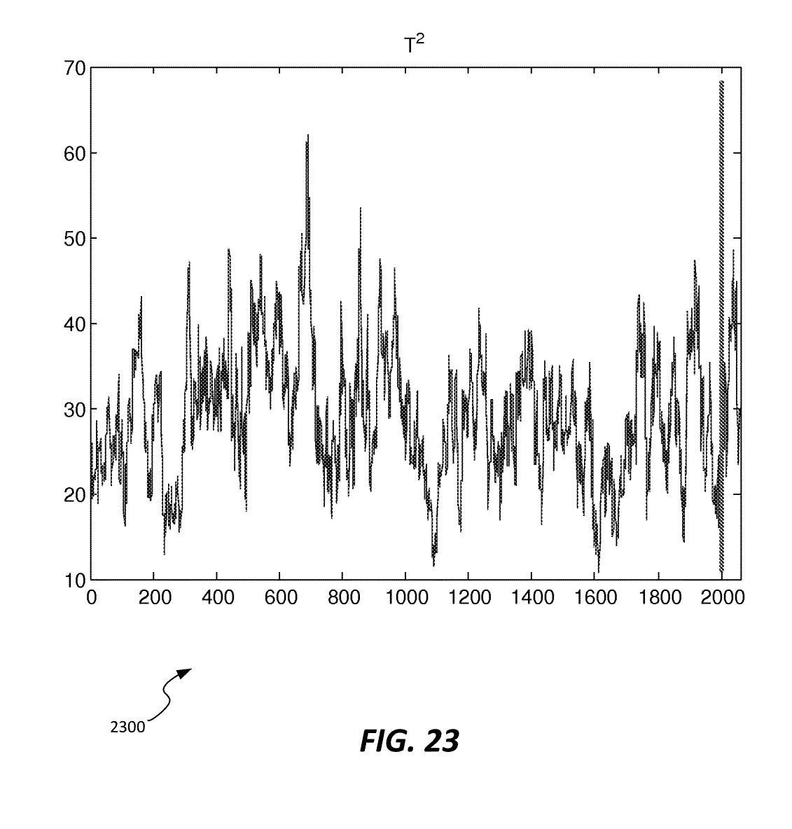

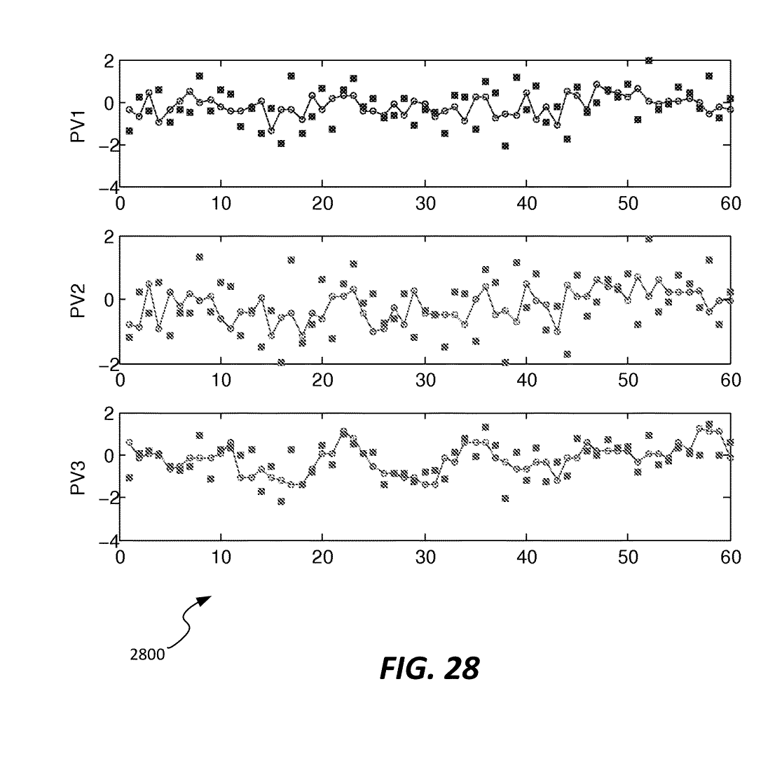

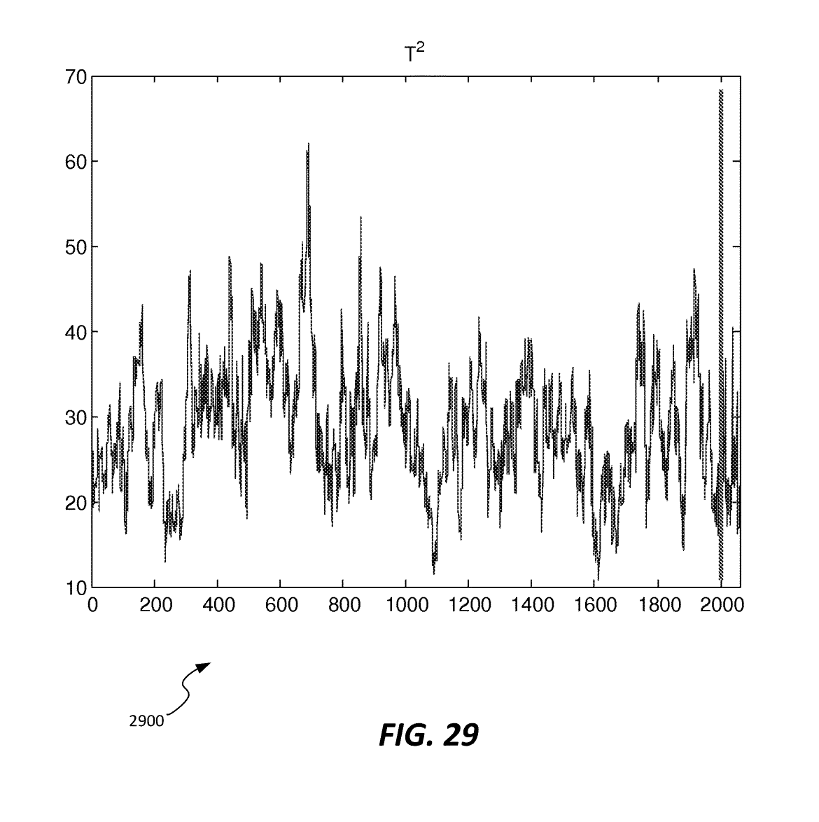

In performing the testing arrangement illustrated in FIGS. 16-29, three fault scenarios are illustrated: a single sensor is missing (FIGS. 16-21), two sensors are missing (FIGS. 22-27), and three sensors are missing (FIGS. 28-29), where one-step-ahead prediction is performed. Additionally, in these scenarios, 60 missing data points are tested, and T² indices are calculated. In particular, for the single sensor and two sensor cases, the T² indices are calculated on:

$$\begin{matrix}{z}_{k}^{r} & {z}_{k - 1} & {z}_{k - 2} & … & {z}_{k - d} \\ {z}_{k + 1}^{r} & {z}_{k}^{r} & {z}_{k - 1} & … & {z}_{k - d + 1} \\ {z}_{k + 2}^{r} & {z}_{k + 1}^{r} & {z}_{k}^{r} & … & {z}_{k - d + 2} \\ ⋮ & ⋮ & ⋮ & ⋮ & ⋮ \\ {z}_{k + n}^{r} & {z}_{k + n - 1}^{r} & {z}_{k + n - 2}^{r} & … & {z}_{k - d + n}^{r}\end{matrix}$$

For the three-sensor case, the T² indices are calculated on:

$$\begin{matrix}{z}_{k}^{r} & {z}_{k - 1} & {z}_{k - 2} & … & {z}_{k - d} \\ {z}_{k + 1}^{r} & {z}_{k} & {z}_{k - 1} & … & {z}_{k - d + 1} \\ {z}_{k + 2}^{r} & {z}_{k + 1} & {z}_{k} & … & {z}_{k - d + 2} \\ ⋮ & ⋮ & ⋮ & ⋮ & ⋮ \\ {z}_{k + n}^{r} & {z}_{k + n - 1} & {z}_{k + n - 2} & … & {z}_{k - d + n}\end{matrix}$$

After a training process, it was determined that the optimal number of principal components for this experiment was 29, with a corresponding averaged mean squared error of 0.2745.

In the experiments shown, the mean squared error for the corresponding experiments, in which individual sensors 1, 2, and 3 were missing, are 0.1465, 0.1477, and 0.4912, respectively. FIGS. 16, 18, and 20 illustrate charts 1600, 1800, and 2000, respectively, in which data reconstruction is illustrated. In each of the charts, the square-shaped data points are reconstructed values, while the open circles correspond to actual values. The corresponding T² indices, in charts 1700, 1900, and 2100 of FIGS. 17, 19, and 21, respectively, show arrangements in which the first 2000 points are training data and the final 60 data points are test data. As illustrated, the range of index values for the test data falls into the range of the T² index for the training data, further validating this methodology.

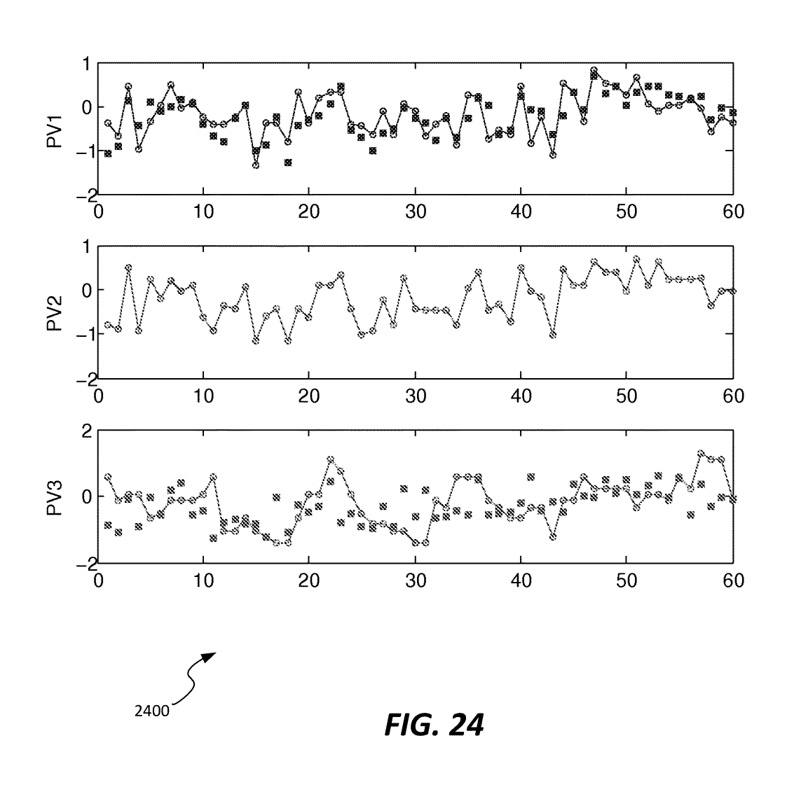

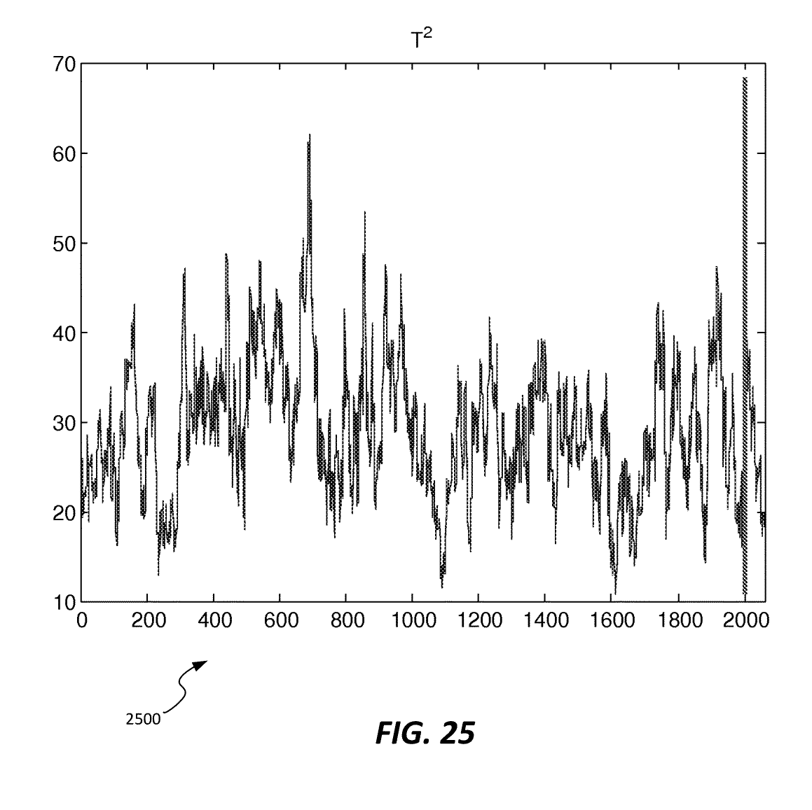

Referring now to FIGS. 22-27, reconstruction results for the two-sensor missing arrangements are illustrated. In these examples, FIGS. 22, 24, and 26 each show charts 2200, 2400, 2600, respectively, illustrating data reconstruction, while FIGS. 24, 25, and 27, respectively show charts 2300, 2500, and 2700 illustrating the T² indices. In these examples, the T² index for the testing data again falls within the range of the training data. Furthermore, the mean squared error for the examples shown are as follows:

Sensors 1, 2 Missing: 1.0998

Sensors 1, 3 Missing: 0.6334

Sensors 2, 3 Missing: 0.5941

FIGS. 28-29 illustrate a chart 2800 of example experimental results and a graph 2900 of T² indices, respectively, for forward data reconstruction in the event that three sensors are missing. In this case, one-step-ahead prediction is performed as noted above. In this example, the mean square error is 2.5423, and again the T² value for the testing data falls within the range of the T² value for training data.

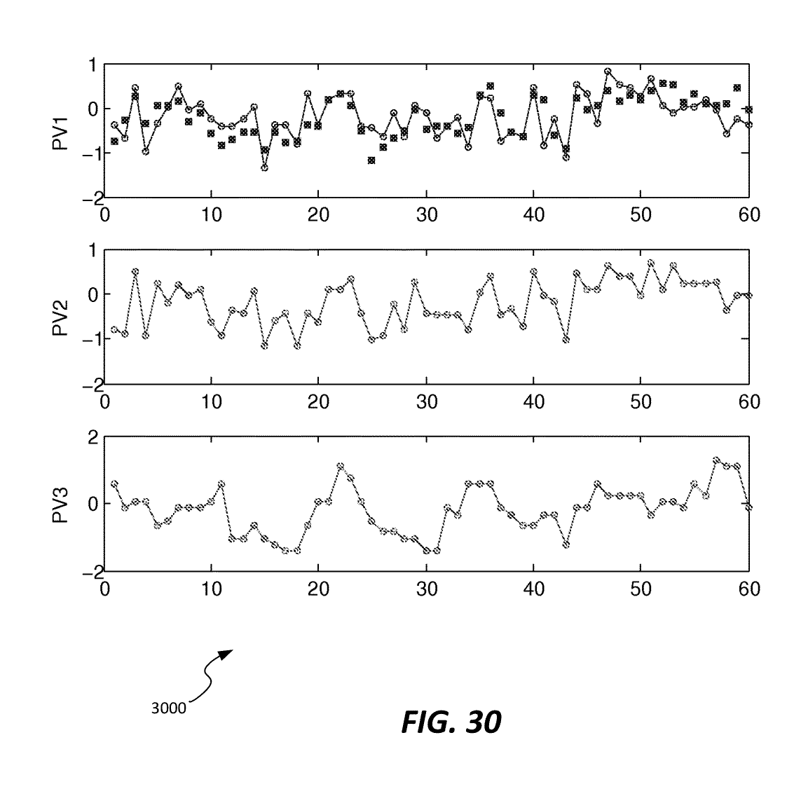

Referring to FIGS. 30-36, example experimental results for backwards data reconstruction are illustrated. The examples of FIGS. 30-36 use the same training and testing data as was used in FIGS. 16-29. Additionally, the appropriate number of principal components is determined by allowing one sensor to be missing at a time, reconstructing 2000 data points using backward data reconstruction and calculating the corresponding mean squared error for each principal component number, and repeating the last step for each case. The average mean squared error for the 3 sensor missing cases is then calculated for each number of principal components, and the best number of principal components is selected based on a smallest averaged mean squared error. Again, three fault scenarios are shown, in which one, two or all three sensors are missing.

In the example embodiments of FIGS. 30-32, charts 3000, 3100, 3200 are respectively shown, illustrating backwards data reconstruction in the event of first, second, and third sensors missing, respectively. In these cases, 60 missing data points are tested, and mean squared error is calculated as follows:

Sensor 1 Missing: 0.1428

Sensor 2 Missing: 0.1351

Sensor 3 Missing: 0.2944

After a training process, a set of 28 principal components was selected, with an average mean squared error of 0.2754.

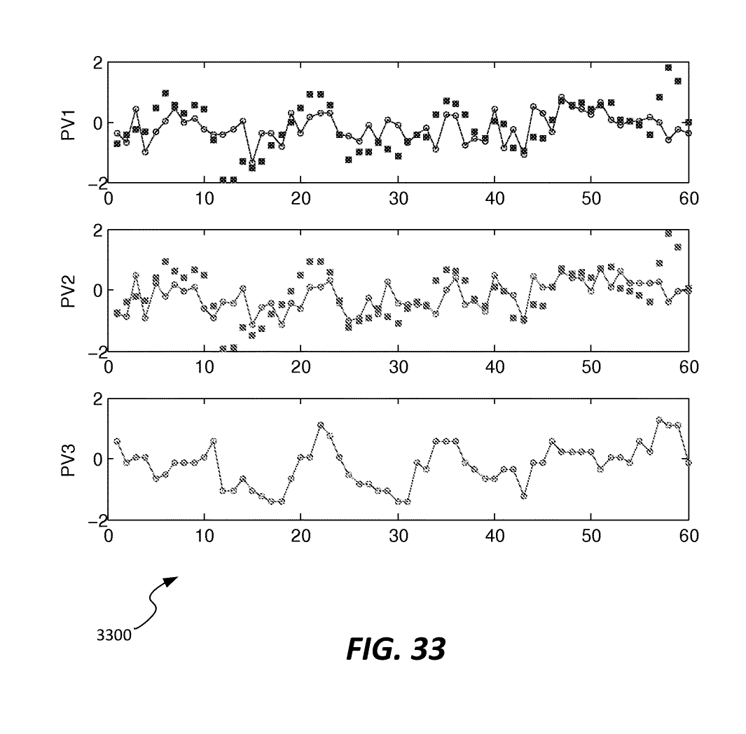

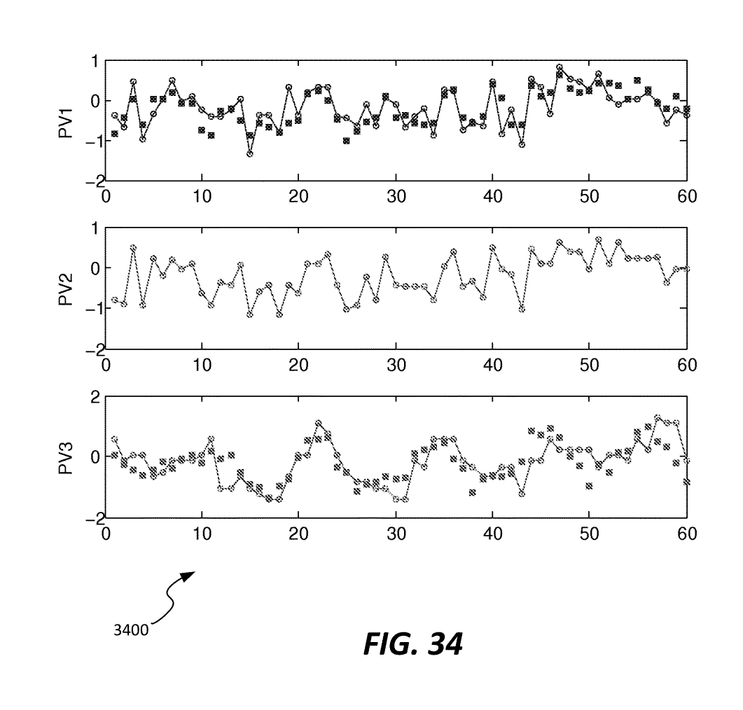

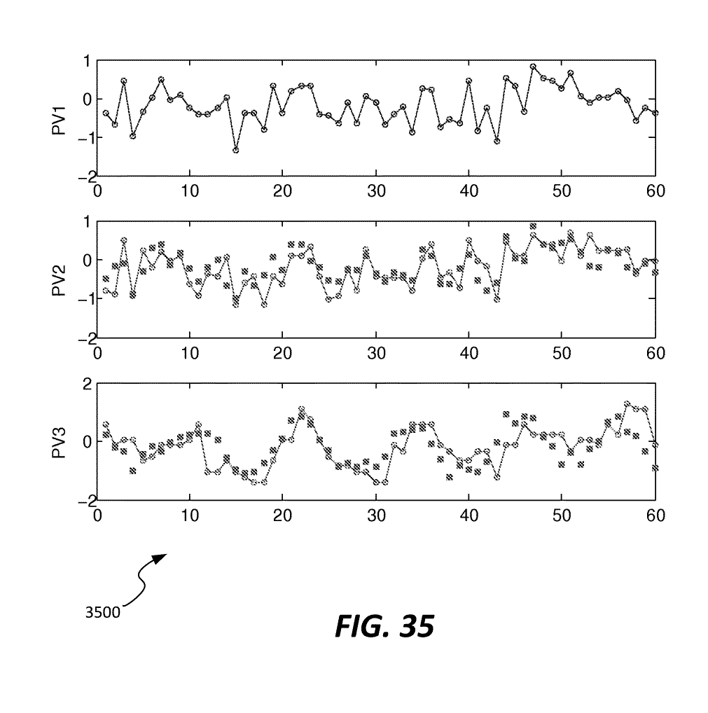

FIGS. 33-35 illustrate charts 3300, 3400, 3500, respectively, for backwards data reconstruction in the event two sensors fail. In particular, chart 3300 of FIG. 33 shows the case where first and second sensors are missing, chart 3400 of FIG. 34 shows the case where first and third sensors are missing, and chart 3500 of FIG. 35 shows the case where second and third sensors are missing. In these cases, mean squared error is calculated as follows:

Sensors 1, 2 Missing: 1.0507

Sensors 1, 3 Missing: 0.3911

Sensors 2, 3 Missing: 0.4680

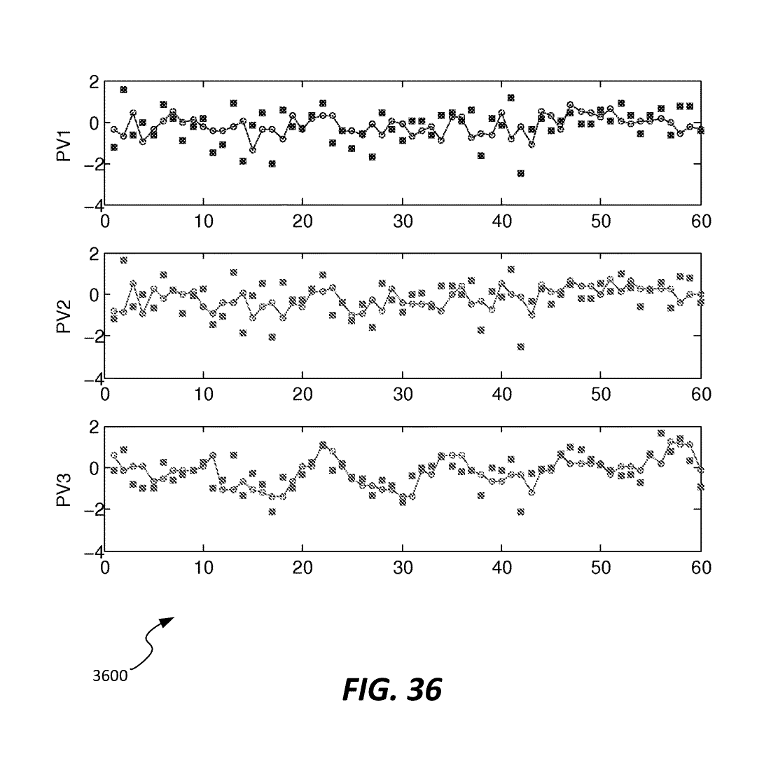

FIG. 36 illustrates a chart 3600 of experimental results for backwards data reconstruction in the event that three sensors are missing. The mean squared error of this reconstruction result is 2.2542.

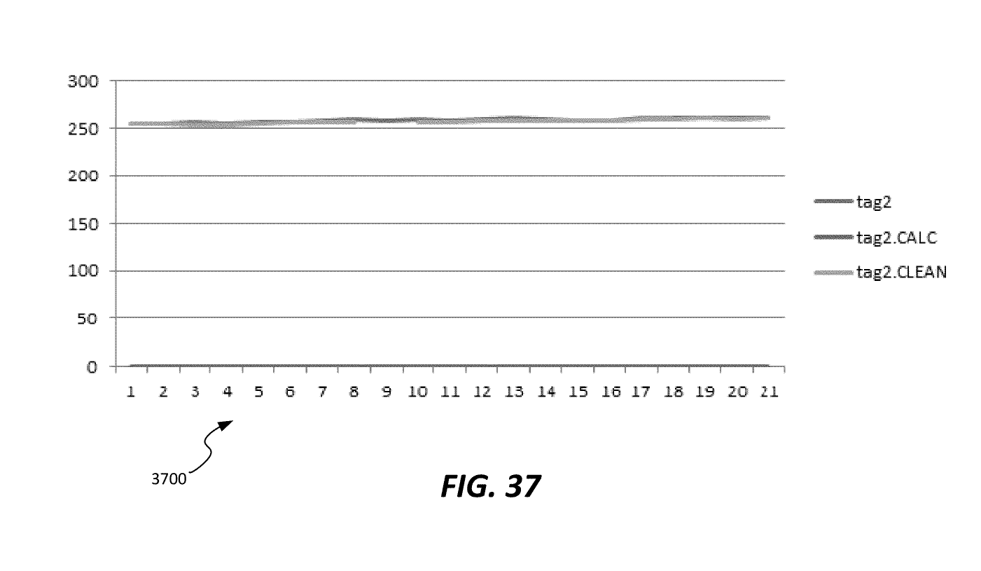

Referring now to FIGS. 37-41, additional examples of data cleansing using the dynamic principal components analysis are provided. In these examples, live process data was used, with errors introduced into input data streams received from a steam generator having five inputs, or tags. These examples illustrate not only the ability to determine that a fault has existed, but also to identify the tag contributing to the fault.

FIG. 37 illustrates a chart 3700 depicting the results of DPCA-based data cleansing on a null value error in tag 2 of five total tags. In this case, over time 1-21, the null value is “forced” but was corrected by the DPCA model-based data cleansing algorithm.

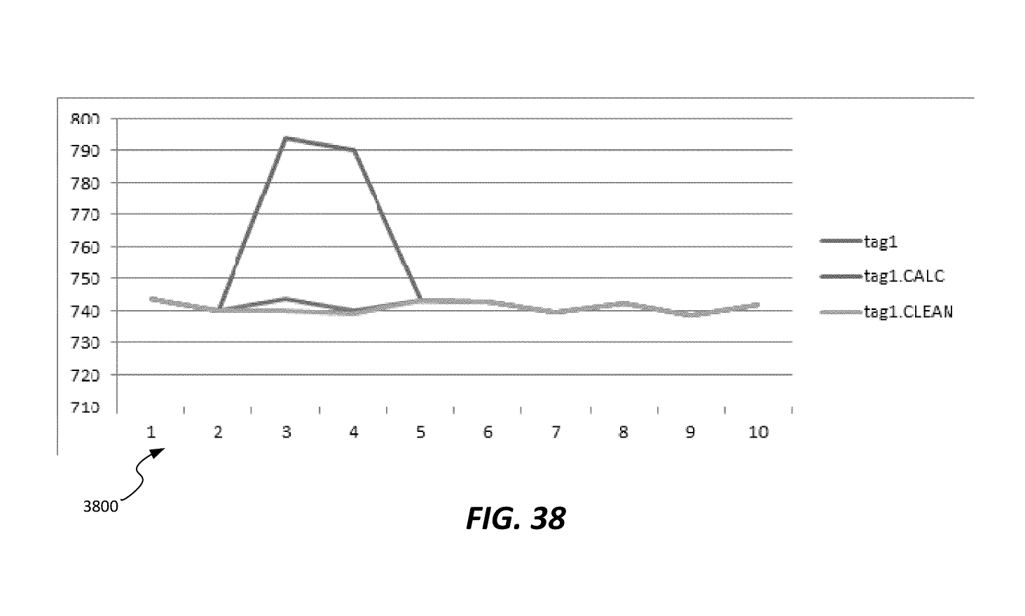

FIG. 38 illustrates a chart 3800 depicting the results of DPCA-based data cleansing on a spike error introduced into tag 1 at time steps 3 and 4. In the chart as depicted, the spike error is immediately detected, identified, and reconstructed by the DPCA model-based data cleansing algorithm. Note that when no error is present, the algorithm does not calculate a reconstructed value but a “cleaned” version of the tag is instead equal to the raw value of the tag. However, at times 3-4, the cleaned version of the tag closely represents the actual tag (comparing “tag1” with “tag1.CLEAN”.

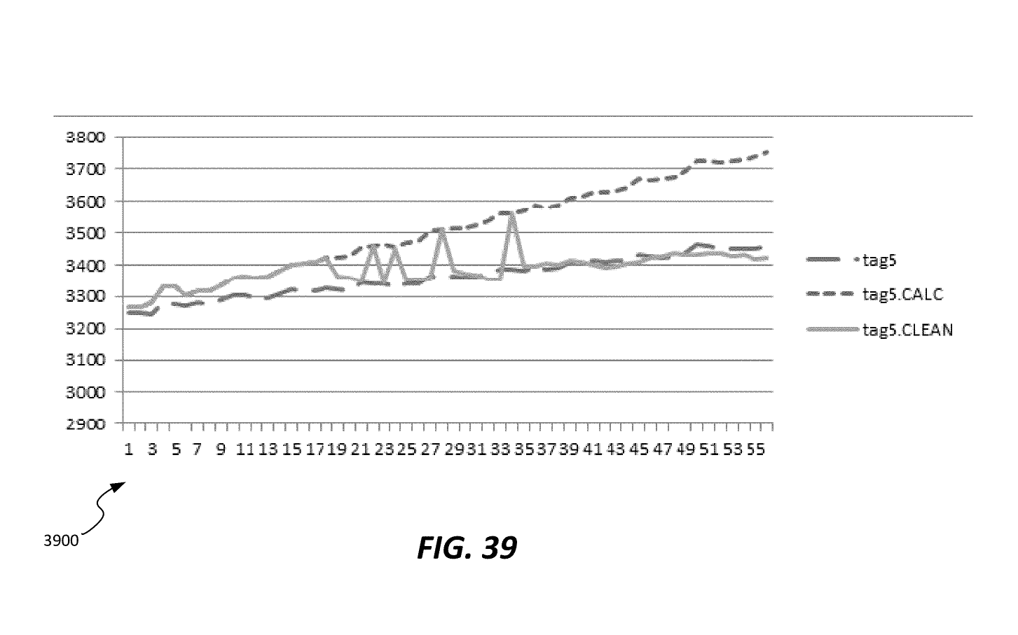

FIG. 39 illustrates a chart 3900 depicting the results of DPCA-based data cleansing on a drift error that has been introduced into tag 5. It can be seen that this error is not detected by the DPCA model-based data cleansing algorithm until the drift has progressed somewhat, and the offset from the raw value is larger (around time step 18). In some cases, it can be seen that the detection is intermittent (sometimes detecting and correcting the error, and sometimes not, such as in time steps 18-29) until the error becomes large enough for consistent detection and correction (around time step 36).

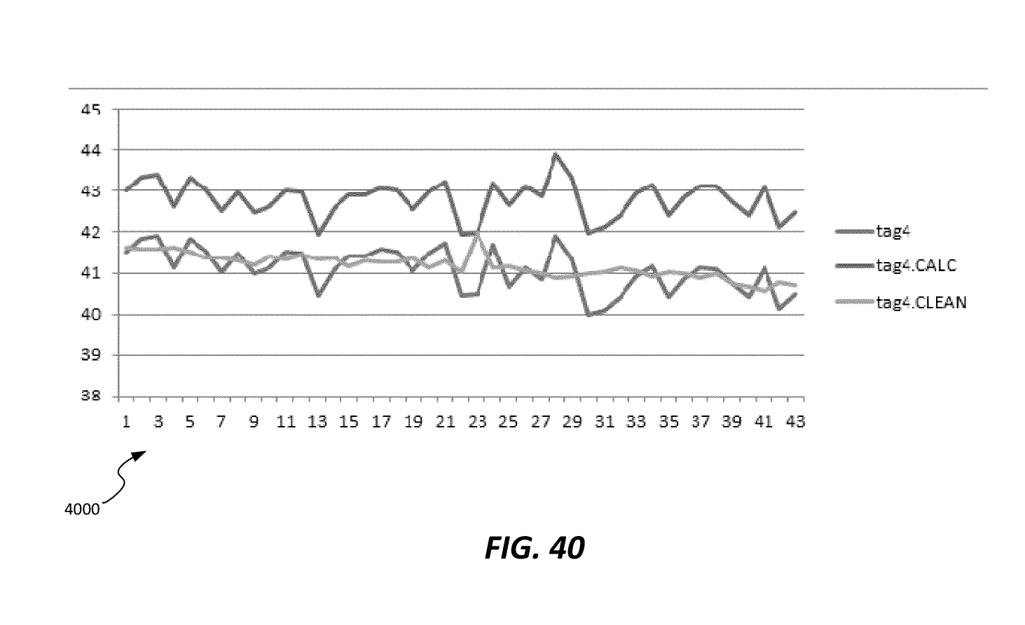

FIG. 40 illustrates a chart 4000 depicting the results of DPCA-based data cleansing on a bias error that has been introduced into tag 4. The error is detected and corrected by the DPCA model-based data cleansing algorithm, and reconstructed values match the raw values quite well. It can be seen however, that at time step 24 or so, the bias error is not detected (i.e. the erroneous value is not corrected and the “tag4.CALC” and “tag4.CLEAN” lines converge). Therefore, it can be seen that the system detects the bias error consistently, except for one occasion where the boas is close to existing data (similar to FIG. 39).

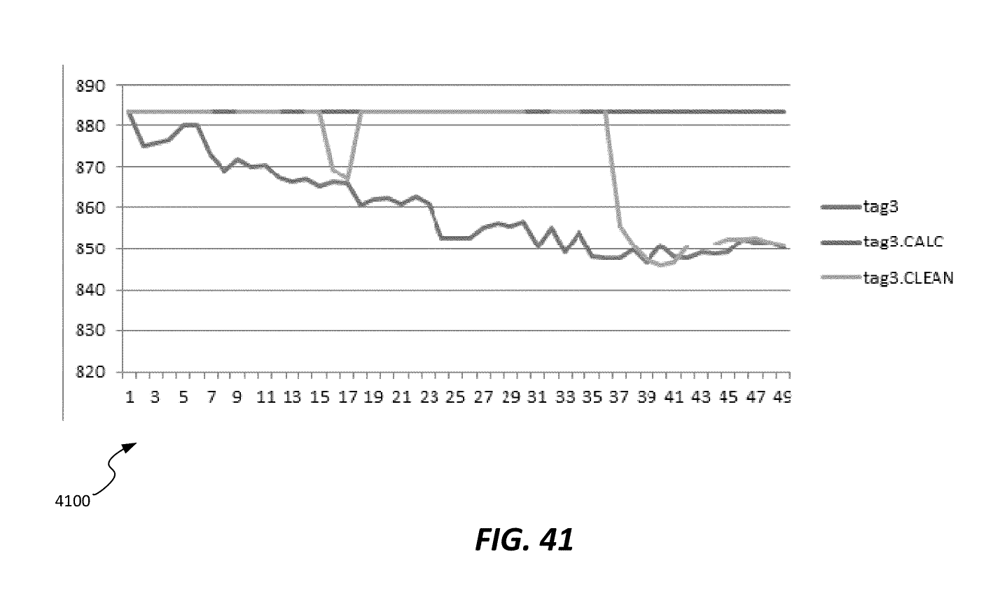

FIG. 41 illustrates a chart 4100 depicting the results of DPCA-based data cleansing on a frozen value error that has been introduced into tag 3. In this example, the error is not detected until the raw value becomes sufficiently different from the frozen value (initially at time step 18, but consistently beginning at about time step 38).

Referring now to FIGS. 42-50, additional details regarding a further method of data cleansing are illustrated that can be implemented within the framework discussed above. In particular, the further method discussed herein provides a mechanism by which, for example, individual data streams can be monitored and cleansed by detecting faults in a single input data stream, or tag, and reconstructing appropriate values in the event of a fault. Such data cleansing techniques can be performed, in various embodiments, using either a batched method or in realtime, thereby allowing the system to operate in conjunction with a live data stream.

Referring specifically to FIG. 42, a further example method 4200 for reconstructing data from a single data stream having a plurality of data points is shown, according to an example embodiment.

In the embodiment shown, the method 4200 for reconstructing data includes receiving a data stream (at step 4202), for example at a data processing framework such as data processing framework 114 of FIG. 1. The method can also include performing a wavelet transform (at step 4204). In example embodiments, the wavelet transform can be a discrete wavelet transform configured to decompose a data stream to a plurality of coefficients. In particular embodiments, the wavelet transform can generate first-order coefficients defining at least a high frequency signature of the data stream, from which faults can be detected.

Specifically, in some embodiments, with respect to a single data stream, a wavelet transform can be performed based on either a continuous or discrete wavelet transform definition. The continuous wavelet transform can be defined using the following equation:

$$X ( a , b ) = \frac{1}{\sqrt{a}} {{\int }_{- ∞}}^{∞} ϕ ( \frac{t - b}{a} ) x ( t ) d t$$

In this case, there are two parameters that are set: “a” is the scale or dilation parameter which corresponds to the frequency information and “b” relates to the location of the wavelet function as it is shifted through the signal, and thus corresponds to the time information.

The discrete wavelet transform can be defined in a variety of ways. In example embodiments, a Haar wavelet is used, defined as follows:

$$ϕ ( t ) = \{ \begin{matrix}1 , & 0 \leq t \leq 1 / 2 \\ - 1 , & 1 / 2 \leq t \leq 1 / 2 \\ 0 , & otherwise\end{matrix}$$

The discrete wavelet transform converts discrete signals into coefficients using differences and sums instead of defining parameters.

In a particular embodiment, data received in an incoming data stream is transformed using the Haar wavelet and decomposed into wavelet coefficients and a threshold is set on the detail coefficient. The detail coefficient represents, in such embodiments, the high frequency portion of the data, and can correspond to a first order detail coefficient. Because outliers and spikes in data will be visible in the high frequency portion of the data, faults will likely be detectable in that portion of data.

In the embodiment shown, the method 4200 includes identifying errors based on first-order coefficients of the transformed data (step 4206). For example, in the outlier detection case, thresholds, such as, for example, four times the standard deviation of detail coefficients can be set so that most of the detail coefficients occur within them (e.g., outside of a standard deviation, or multiple thereof, of expected data variations). In this way, only the outliers, which should appear as very large detail coefficients, will be highlighted. In the case that there is a frozen value, that is, a data stream remains for a short period of time at exactly the same value, and the detail coefficients become zero. If there are more than 3 zero magnitude detail coefficients in a row, and unless the process is stationary, the data stream (and associated sensor) is assumed to have frozen. In the case of a linear drift (or other similar drift types), successive detail coefficients remain exactly the same (e.g., resulting in monotonically increasing or decreasing values). Accordingly, various other types of drift can be identified from the differences between the first level detail coefficients.

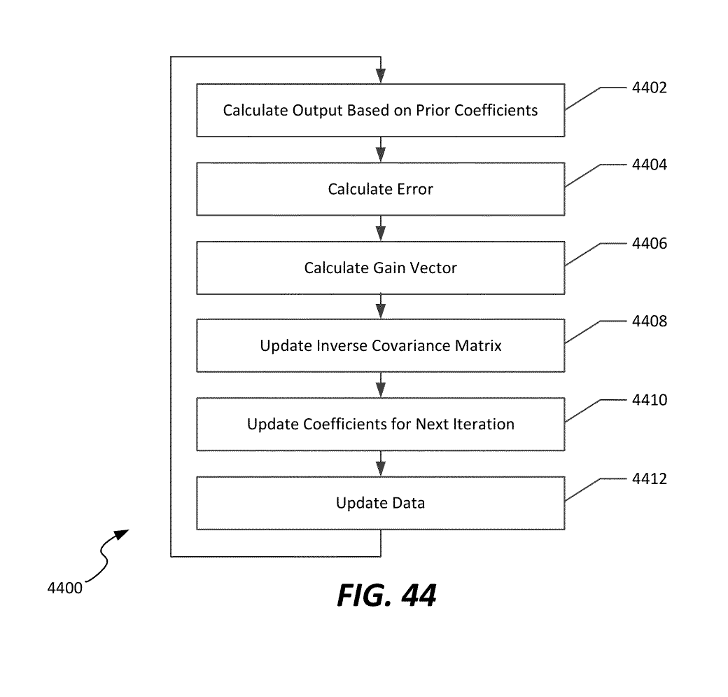

In the embodiment shown, after faults in data are detected, the method 4200 can include reconstructing data (step 4208). In example embodiments, faulty data can be reconstructed using a recursive least squares process. In particular embodiments, an auto-regressive recursive least squares process can be performed. In further embodiments, a forgetting factor can be applied to the recursive least squares process. Details regarding such data reconstruction techniques are described in further detail below in connection with FIGS. 44-46.

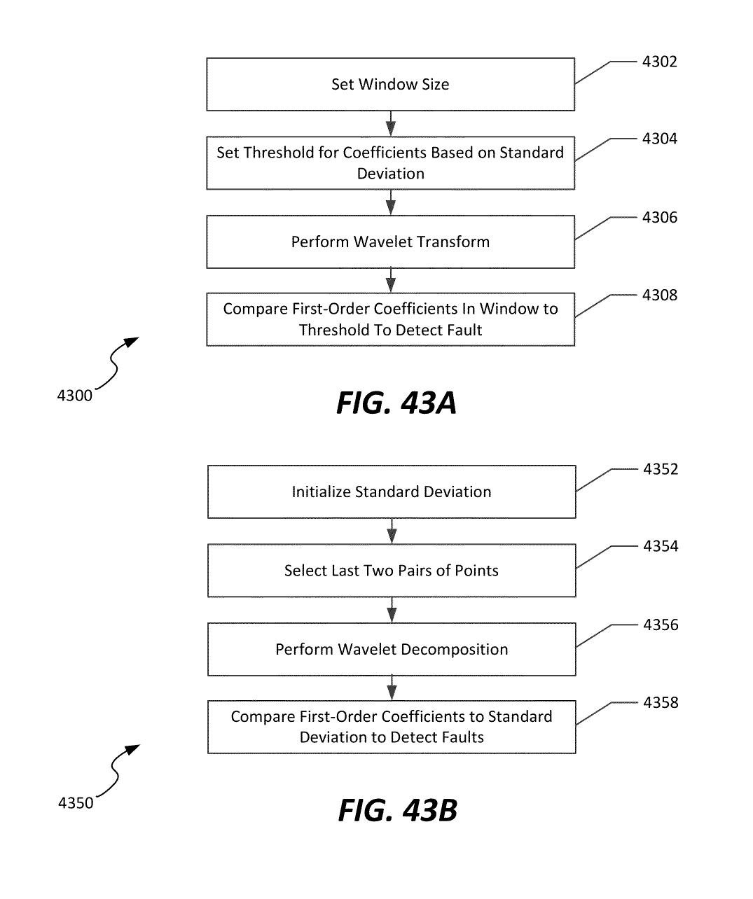

FIG. 43A illustrates a method 4300 of batch fault detection using a wavelet transform, according to an example embodiment. In example embodiments, the batch fault detection method disclosed herein can be used to perform steps 4204, 4206 of FIG. 42, above.

In the example embodiment shown, an aggregated collection of data from a single data stream is used at a particular window size, set in a window setting operation (step 4302). Additionally, a threshold is set for detail coefficients, for example based on a known standard deviation (step 4304). In example embodiments, the window size can be large enough such that detail coefficients represent noise in data (typically 14-128 data points). Model parameters are then performed on the collection of data within the selected window (step 4306). First order coefficients are then compared (step 4308) to determine if such coefficients are zero (e.g., indicating a stuck value), constant (e.g., indicating drift), very large (e.g., outside of a standard deviation or a multiple thereof, indicating a spiked value or other malfunction), or otherwise indicate a fault.

FIG. 43B illustrates a method 4350 of realtime fault detection using a wavelet transform, according to an example embodiment. In the example method 4350 shown, an initial standard deviation is established (step 4502), for example by training the wavelet transform/decomposition process on known data to establish a noise threshold for typical data. The method 4350 further includes training the wavelet transform on the last two pairs of points in time (step 4354) and performing a wavelet decomposition on those few data points (step 4356). First order coefficients of this transform can then be compared to the standard deviation to detect faults (step 4358) in a manner similar to the above as described in FIG. 43A.

Once a fault is detected, data reflecting that fault can be corrected using a data reconstruction process. In some embodiments discussed herein, reconstruction of data can be performed using a recursive least squares method. For example, FIG. 44 illustrates a method 4400 of performing a faulty data reconstruction using auto-regressive recursive least squares.

The method 4400 includes calculating an output based on prior coefficients (step 4402). For example, an output y can be calculated using a previous set of model parameters, as follows:

y(i)=x^{T}(i)param(i−1)

The method 4400 further includes calculating an error term for a desired signal (step 4404). This can be performed based on the following:

e(i)=y(i)−x^{T}param(i−1)

The method 4400 also includes calculating a gain vector (step 4406). The gain vector, in some embodiments, can be calculated from k, as follows:

$$k ( i ) = \frac{P ( i - 1 ) x ( i )}{λ + {x}^{T} ( i ) P ( i - 1 ) x ( i )}$$

The method 4400 includes updating an inverse covariance matrix (step 4408). In example embodiments, the inverse covariance matrix update is presented as:

P(i)=λ⁻¹[P(i−1)−k(i)x^{T}(i)P(i−1)]

The method 4400 also includes updating coefficients for a next iteration on a next fault (step 4410), and updating data in a data stream with the corrected data (step 4412). Updating coefficients can be illustrated, in example embodiments, by the following equation:

param(i)=param(i−1)+k(i)e(i)

The updated data is provided by replacing output y(1) in the above calculation with a new version of that value, based on the updated coefficients. It is noted that the method 4400 can be performed iteratively, for example on a next window or next fault that is observed.

In some embodiments, the above recursive least squares methodology can use a model order and a forgetting factor. The model order determines the number of points to be used in the RLS process, and the forgetting factor is a user-defined parameter between zero and one that determines the importance given to previous data (i.e. data prior to that specified by the model order). The smaller the forgetting factor, the smaller the contribution of previous values. In other words, a forgetting factor of zero means that just the points specified by the model order are used. In addition, the recursive least squares algorithm is typically initialized before being applied, so errors detected during the initialization of the algorithm cannot be reconstructed. It is noted that model order is relevant to the batched version of the methods discussed herein, but is not a concern relative to a realtime implementation, since only current parameters are typically buffered.

In order to permit the reconstruction of erroneous data as it is detected by the detection algorithm in an online or realtime implementation (e.g., as used in conjunction with the realtime wavelet transform of FIG. 43B), the process is performed such that coefficients are calculated at each time step after initialization, and buffered for the time period of the window size of the error detection algorithm. In addition, a buffer of previous values equal to the length of the window size, plus the model order, plus any additional values determined by the forgetting factor, is maintained. By way of example, if the error detection algorithm has a window size of 16 time steps, and the algorithm detects at time=t that an error occurred at time=t−15 (i.e. at the beginning of the window), then the recursive least squares process needs its model coefficients from time=t−16 as well as the previous values specified by the model order (assuming a model order of 5, this would be the values from time=t−16 through t−20) to calculate a reconstructed value for the erroneous data point at time=t−15. This assumes a forgetting factor of zero, otherwise even more previous data points would need to be available. Once a window has been established, there will no longer be any need to buffer RLS with FF model coefficients, because errors would be detected in real-time and only the current values of the recursive least square coefficients would be needed, rather than any from past time steps. In such circumstances a buffer of the previous values would still be used, but the buffer size would be smaller, including the model order plus earlier values specified by the forgetting factor.

In the recursive least squares methodology, initial parameter coefficients can be set as zero if there is no prior knowledge. Additionally, the initial value of the covariance matrix used should be set as a large number multiplied by the identity matrix. The exact value of this “large number” matters less and less as more data points are considered; as noted below, in some cases up to 1000 data points are used. Further, in example embodiments the system is started one data point ahead of the model order, p (essentially the number of coefficients). As a result, a fault within the first p data points may not be correctly reconstructed in this application.

It is noted that the recursive least squares reconstruction algorithm can work in tandem with any fault detection algorithm, because its main requirement is the prior knowledge of fault locations. Aside from the user-defined model order and forgetting factor, only the fault location is necessary for the reconstruction algorithm to occur.

Further, given that the reconstruction method employs an autoregressive algorithm, its performance can be expected to degrade if there are multiple consecutive erroneous data points, such as may occur during a loss of communication. In this case, the algorithm would continue using the last model calculated prior to the fault, and continue in a trend that eventually departs from the direction of the actual data.

Generally, the system 4500 receives a data stream, illustrated as sequential input x(i). That input data point enters a delay period 5402, and is received at a recursive least squares block 4504 as the next previous input, x(i−1). The recursive least squares block 4504 outputs a corrected value, which is compared to the value from the immediate previous iteration. The result (e.g., the error amount, is fed back to the least squares block 4504 for use in updating coefficients and maintaining corrected data.

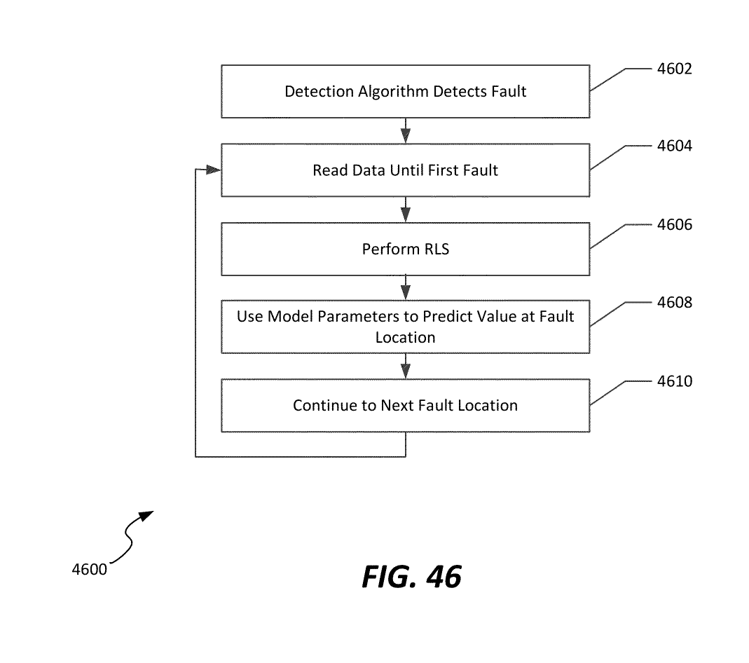

FIG. 46 illustrates a method 4600 of performing a fault reconstruction from a data stream in which faults have been detected, according to an example embodiment. The method 4600 includes, in some cases, a detection algorithm that detects faults (step 4602); for example, faults can be loaded from a wavelet transform-based fault detection process performed by a data processing framework. In example embodiments, the method 4600 can be used with a batch-based or realtime wavelet transform method. In some optional embodiments, the method 4600 includes reading data until reaching a first fault location (step 4604).

It is noted that, in alternative embodiments, and in particular those in which a realtime implementation is provided, rather than loading data and reading that data until reaching a fault location, steps 4602-4604 can be replaced by simply receiving an indication of a fault from a fault detection system, such as the wavelet transform fault detection systems described above. Accordingly, the remaining steps discussed herein can be performed in either a batch mode (offline) or realtime implementation of the fault detection and data cleansing systems described herein.

At that location, the auto-regressive recursive least squares operation described in connection with FIG. 44 is performed (step 4606). This can include, in optional embodiments, use of the forgetting factor and model order issues as noted above. Model parameters are also optionally used to predict a value at the faulty value location and replace that value at the location (step 4608). The method 4600 proceeds from the current fault location to the next fault location (step 4610) and returns to step 4604, proceeding to the next fault.

Referring to FIGS. 44-46 generally, although the recursive least squares process described herein obviates the need for other simple operators, faults that are present for longer periods of time may not be accurately predicted because the model will remain unchanged. If the model is updated with the replaced values, then there will be a cumulative error effect as the fault continues. However, the recursive least squares method still leads to equal or better estimates than the simple operators in many cases. It is also useful to note that when the forgetting factor is set very close to zero and the model order p is chosen as 2, it is equivalent to linearly extrapolating the last two points in the data set.

Regarding the forgetting factor applied, it is noted that as the forgetting factor approaches 0, the result of applying recursive lest squares approaches that of the linear regression (since the model order is 2). The closer the forgetting factor gets to 1, the better the estimate. In some embodiments, it is optimal to use a forgetting factor between 0.95 and 1. However, where the data set is relatively stationary a high forgetting factor is reasonable. For highly non-stationary data, a low forgetting factor should be chosen so that previous data does not affect future predictions.

Regarding model order, it is observed that using a higher model order results in a more accurate estimate. In the case of non-stationary data, a lower model order might be used such that only the most recent values are useful in making a future prediction. Forgetting factor and model order parameters could potentially be optimized by cross comparing and determining the ideal combination, a process that could be automated so that the best combination of model order and forgetting factor can be determined.

Regarding an initial value of a P-matrix useable in the recursive least squares data reconstruction, a large number (e.g., over about 1000 data points) can be used to ensure that any effect of changing an initial value of the P-matrix has little effect on the prediction accuracy of the methodology.

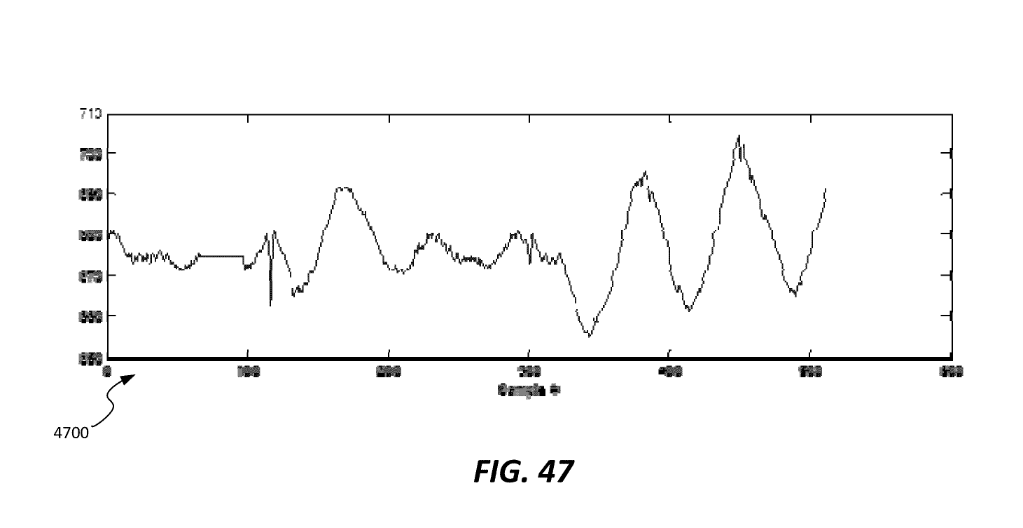

Referring now to FIGS. 47-51, examples of detecting specific errors and reconstructing data for those errors are described.

FIG. 47 illustrates a chart 4700 depicting a frozen value detected in a single data stream fault detection and reconstruction system. In the frozen value case, the fault is identified when several successive first level detail coefficients were exactly zero. Through this, a wavelet transformation can be used to identify where the fault began and ended. It is noted that detail coefficients of a wavelet transformation at the first level can be zero or close to zero both when the process is stuck (faulty) and stationary (still operational) so it is difficult to identify the difference between the normal process and a fault. Further, depending on the data set, different numbers of identical measurements can signify a frozen value fault. Accordingly, in the present wavelet transformation fault detection, three successive zero detail coefficients were considered to be a frozen value fault (corresponding to 6 frozen values), since the fault was artificially added.

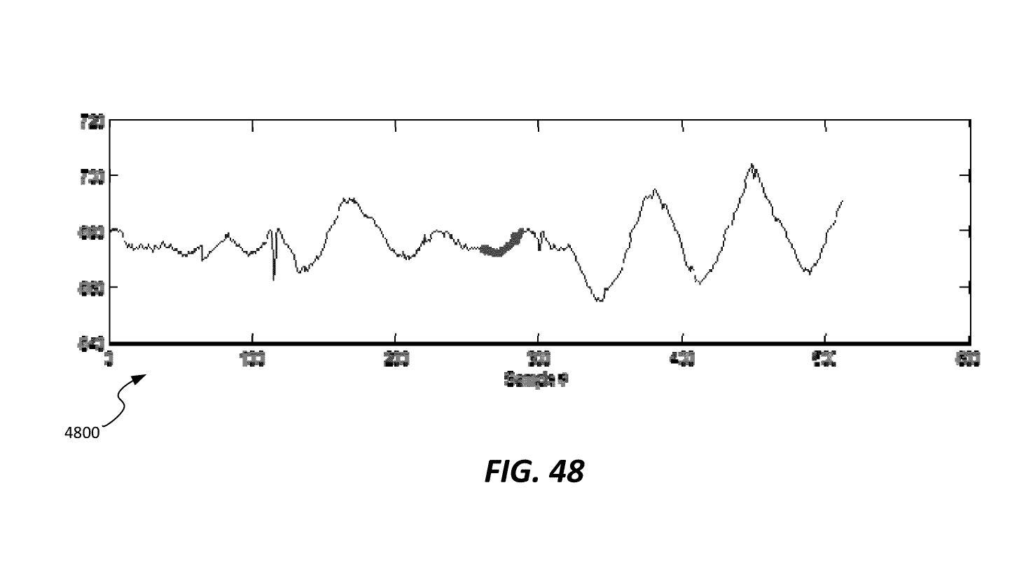

FIG. 48 illustrates a chart 4800 depicting a linear drift error detected in a single data stream fault detection and reconstruction system. In the example shown, it is noted that because the linear drift that was added was within the normal range, it would be difficult to identify it using other common methods. However, by analyzing which of the detail coefficients (and in particular the first level detail coefficients) of the wavelet transform remain the same, the wavelet transform can be used to highlight the portion of the data that is affected. In further embodiments, this approach can be extended to an approximately linear drift by introducing a tolerance parameter, or a quadratic drift by decomposing the data to one further level (e.g., using differences among second level detail coefficients). Accordingly, the wavelet transformation can be used to identify slope based faults like the ones presented here.

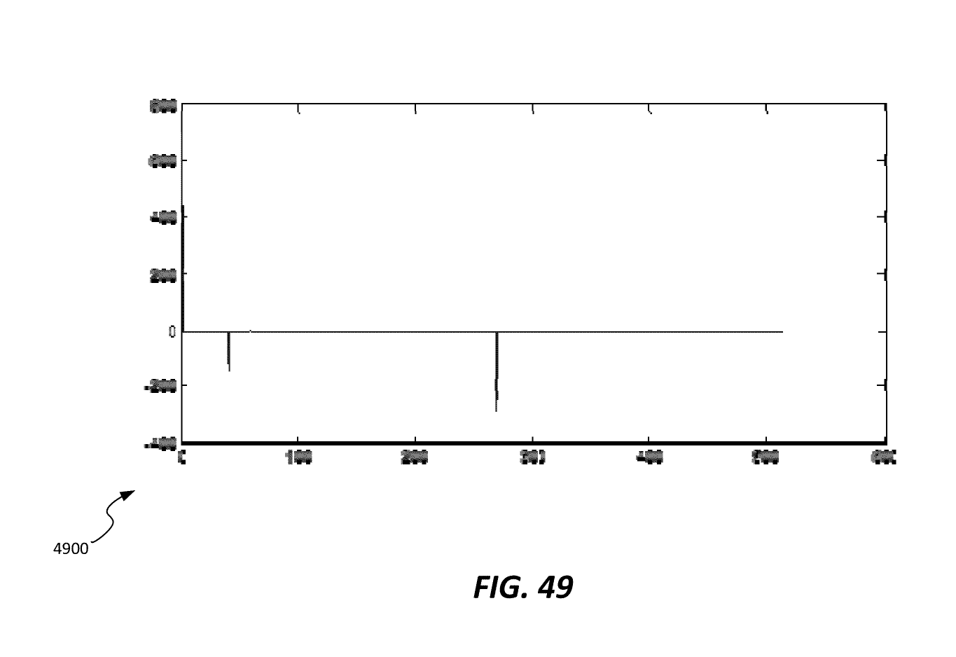

FIG. 49 illustrates a chart 4900 depicting error detection of a spiked value detected in a single data stream fault detection and reconstruction system. In particular, chart 4900 displays first order coefficient data relating to a data set in which two spikes are introduced. As seen in the wavelet transform data, it can be seen that a threshold of +/−150 would permit detection of the two spike errors.

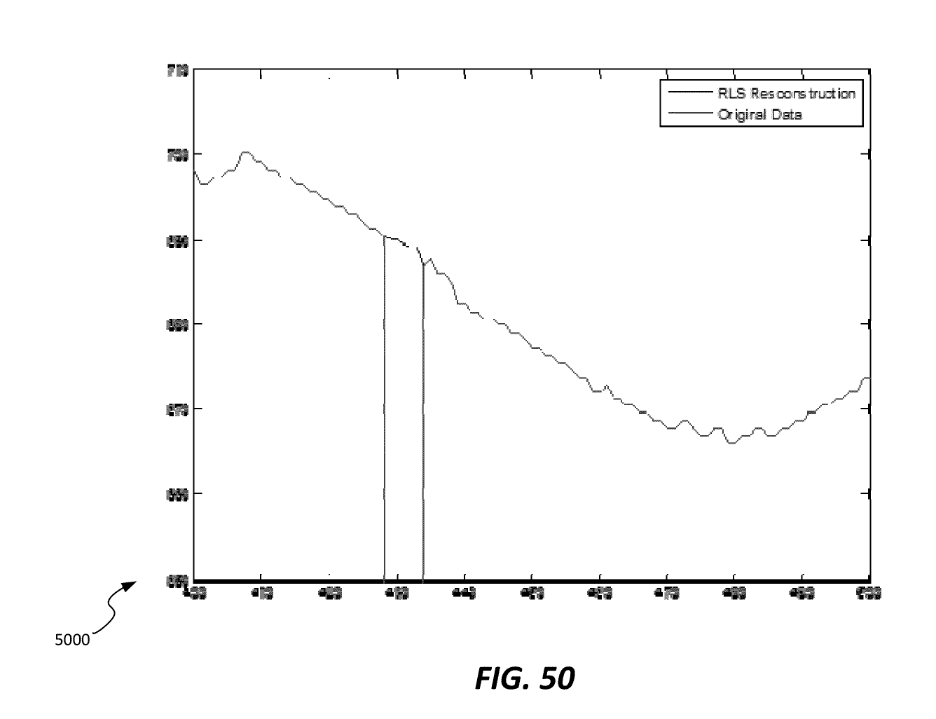

FIG. 50 illustrates a chart 5000 depicting detection and reconstruction of a null value detected in a single data stream fault detection and reconstruction system. As seen in chart 5000, a null value is replaced by data in the area of time 430. It is noted that, although the reconstruction shown in chart 500 looks convincing, this single tag cleansing methodology has been compared to other common simple reconstruction methods such as substituting with the mean or interpolating, both for single errors and consecutive errors, to confirm its performance. It is noted that the recursive least squares provides a lowest error percentage relative to an actual value, as illustrated in Table 1.

TABLE 1
Comparison of Recursive Least Squares
Effectiveness for Data Reconstruction

| | | | Interpolation | Mean of |
|---|---|---|---|---|
| | Actual | RLS Value | Value | Data Set |
| Fault Type | Value | (% Error) | (% Error) | (% Error) |
| Consecu- | 690.478 | 690.177 (0.04) | 691.063 (0.08) | 683.232 (1.05) |
| tive | 689.600 | 690.043 (0.06) | 691.647 (0.30) | 683.232 (0.92) |
| | 689.600 | 689.627 (0.003) | 692.232 (0.38) | 683.232 (0.92) |
| | 687.844 | 689.241 (0.20) | 692.817 (0.72) | 683.232 (0.67) |
| | 686.968 | 689.312 (0.34) | 693.402 (0.94) | 683.232 (0.54) |
| Single (1) | 667.904 | 667.71 (0.03) | 668.33 (0.06) | 681.92 (2.10) |
| Single (2) | 496.766 | 496.171 (0.11) | 496.766 (0) | 473.559 (4.67) |

Overall, when a low forgetting factor is used in non-stationary data sets and a high forgetting factor is used in relatively stationary data sets, average reconstruction error over various data sets, types of faults and initial conditions was found to be approximately 0.1% for artificially created faults.

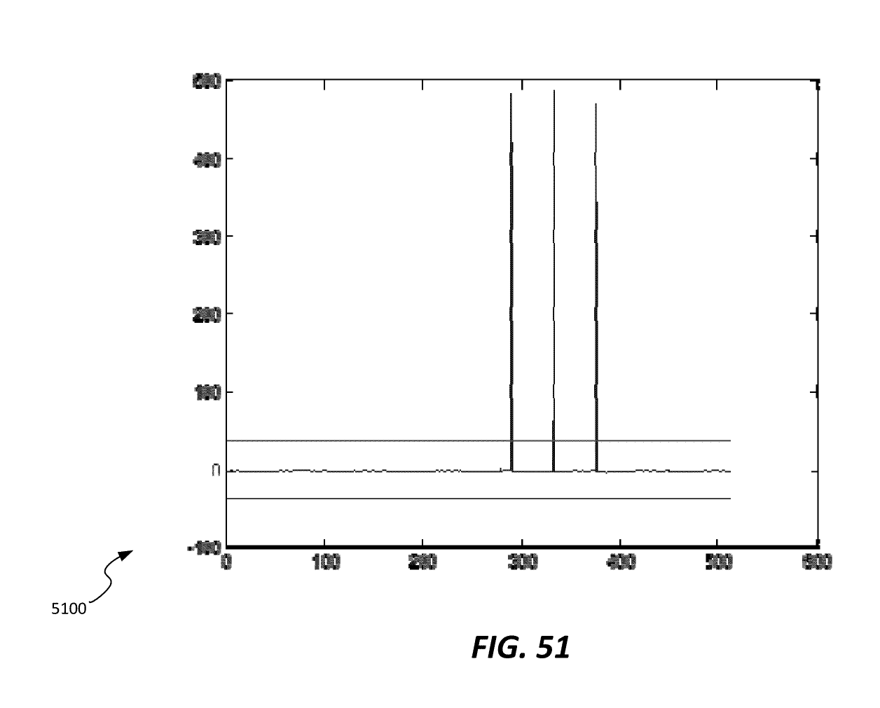

FIG. 51 illustrates a chart 5100 depicting an example wavelet-based fault detection, according to an example embodiment. In chart 5100, three spike faults were introduced, and are shown relative to thresholds (horizontal lines introduced in the data set) that represent multiples of the standard deviation of the high frequency wavelet coefficients. As with the results of FIG. 50, it can be seen that use of recursive least squares results in highly accurate data reconstruction, seen in Table 2:

TABLE 2
Accuracy of Reconstruction of Three Spike Errors

| Fault | Actual Value | RLS (% Error) | Ordinary Least Squares |
|---|---|---|---|
| 1 | 687.844 | 687.854 (0.001%) | 687.404 (0.06%) |
| 2 | 692.237 | 692.044 (0.03%) | 692.677 (0.06%) |
| 3 | 667.904 | 668.724 (0.12%) | 668.676 (0.12%) |

Referring generally to FIGS. 1-51, it is noted that the systems and methods of the present disclosure provide for a configurable framework in which various operators can be implemented, and in which operators for data reconstruction have been implemented successfully, for reconstructing missing and faulty records. These include forward data reconstruction (FDR) and backward data reconstruction (BDR) approaches, as well as faulty sensor identification. The FDR uses partial data available at a particular time along with the past data to reconstruct the missing or faulty data. The BDR uses partial data available at a particular time along with the future data to reconstruct the missing or faulty data. Therefore, the methods implemented in the operators described herein make the best use of information that is available at a particular time. When the initial portion of the data sequence are normal for at least d consecutive time intervals, FDR could be used. If this is not the case, BDR could be used. The results indicate that the methods could effectively reconstruct missing records not only when parts of the sensors are missing but also when all the sensors are missing.

Furthermore, and as noted above, example methods exist for identifying particular fault sources by performing a fault identification process, or by applying single tag cleansing systems to each tag or input stream that is received from an input stream not otherwise easily interrelated to other data streams. The single tag data cleansing process described herein can be used in conjunction with a data reconstruction process, such as an auto-regressive recursive least squares process, to provide either batch or realtime data cleansing on a single input stream, which may be isolated or otherwise inappropriate for DPCA analysis.

Referring generally to the systems and methods of FIGS. 1-51, and referring to in particular computing systems embodying the methods and systems of the present disclosure, it is noted that various computing systems can be used to perform the processes disclosed herein. For example, embodiments of the disclosure may be practiced in various types of electrical circuits comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, aspects of the methods described herein can be practiced within a general purpose computer or in any other circuits or systems.

Embodiments of the present disclosure can be implemented as a computer process (method), a computing system, or as an article of manufacture, such as a computer program product or computer readable media. The computer program product may be a computer storage media readable by a computer system and encoding a computer program of instructions for executing a computer process. Accordingly, embodiments of the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media. Further, the disclosed methods' stages may be modified in any manner, including by reordering stages and/or inserting or deleting stages, without departing from the overall concept of the present disclosure.

The above specification, examples and data provide a complete description of the manufacture and use of the composition of the invention. Since many embodiments of the invention can be made without departing from the spirit and scope of the invention, the invention resides in the claims hereinafter appended.

1. A computer-implemented method for detecting faulty data in a data stream, the method comprising:
receiving an input data stream at a data processing framework;
performing a wavelet transform on the data stream to generate a set of coefficients defining the data stream, the set of coefficients including one or more coefficients representing a high frequency portion of data included in the data stream; and
determining, based on the high frequency portion of data, existence of a fault in the input data stream.

2. The computer-implemented method of claim 1, wherein the wavelet transform comprises a discrete wavelet transform.

3. The computer-implemented method of claim 2, wherein the wavelet transform comprises a first level wavelet decomposition.

4. The computer-implemented method of claim 1, further comprising reconstructing data at the fault using an auto-regressive recursive least squares process.

5. The computer-implemented method of claim 4, wherein the recursive least squares process has a forgetting factor defining a relative weighting of previous data received in the input data stream.

6. The computer-implemented method of claim 4, wherein the wavelet transform is performed on a version of the data stream including previously reconstructed data.

7. The computer-implemented method of claim 1, wherein the fault comprises at least one of a frozen value fault, a drift fault, a missing value, or a spiked value fault.

8. The computer-implemented method of claim 1, wherein the wavelet transform is applied to the data stream in real time.

9. The computer-implemented method of claim 8, wherein the wavelet transform uses two pairs of data points, a current standard deviation, a mean value, and a timestamp.

10. The computer-implemented method of claim 9, wherein a value in the data stream associated with a fault that is detected is replaceable in realtime.

11. The computer-implemented method of claim 1, further comprising:
performing a separate wavelet transform on each of a plurality of different input data streams to generate coefficients defining each of the plurality of different input data streams.

12. The computer-implemented method of claim 1, wherein the input data stream comprises a data stream of sensor data from a hydrocarbon production facility.

13. The computer-implemented method of claim 1, wherein determining existence of the fault is based on differences between coefficients representing the high frequency portion of data or based on at least one threshold.

14. A system comprising:
a communication interface configured to receive a data stream;
a processing unit;
a memory communicatively connected to the processing unit, the memory storing instructions which, when executed by the processing unit, cause the system to perform a method of detecting faulty data in the data stream, the method comprising:
performing a wavelet transform on the data stream to generate a set of coefficients defining the data stream, the set of coefficients including one or more coefficients representing a high frequency portion of data included in the data stream; and
determining, based on the high frequency portion of data, existence of a fault in the input data stream.

15. The system of claim 14, wherein the instructions comprise a data processing framework useable to process the data stream received at the interface.

16. The system of claim 14, wherein the communication interface is configured to receive a plurality of different data streams.

17. The system of claim 16, wherein the plurality of different data streams correspond to data received from sensors associated with an industrial process.

18. The system of claim 17, wherein the sensors are used to monitor operations of a hydrocarbon production facility.

19. The system of claim 14, wherein the instructions cause the system to further perform reconstructing data at the fault using an auto-regressive recursive least squares process.

20. The system of claim 19, wherein the recursive least squares process has a forgetting factor defining relative weighting of previous data received in the input data stream.

21. A computer-readable medium having computer-executable instructions stored thereon which, when executed by a computing system, cause the computing system to perform a method for reconstructing data for a dynamic data set having a plurality of data points, the method comprising:
receiving an input data stream at a data processing framework;
performing a wavelet transform on the data stream to generate a set of coefficients defining the data stream, the set of coefficients including one or more coefficients representing a high frequency portion of data included in the data stream;
determining, based on the high frequency portion of data, existence of a fault in the input data stream; and
reconstructing data at the fault using a recursive least squares process, wherein the recursive least squares process has a forgetting factor defining relative weighting of previous data received in the input data stream.

22. A computer-implemented method for reconstructing data, the method comprising:
receiving a selection of one or more input data streams at a data processing framework;
receiving a definition of one or more analytics components at the data processing framework;
applying a dynamic principal component analysis to the one or more input data streams;
detecting a fault in the one or more input data streams based on at least one of a prediction error or a variation in principal component subspace generated based on the dynamic principal component analysis;
identifying at least one of the one or more input data streams as a contributor to the fault based at least in part on a determination of a reconstruction-based contribution of the at least one input data stream to the fault; and
reconstructing data at the fault within the one or more input data streams.

23. The computer-implemented method of claim 22, wherein identifying the at least one of the one or more input data streams as a contributor to the fault is based at least in part on a determination of a reconstruction-based contribution of each of the plurality of input data streams to the fault.
